(19) United States
(12) Patent Application Publication
(10) Pub. No.: US 2025/0287282 A1
(43) Pub. Date: Sep. 11, 2025

(54) BLUETOOTH ASSISTED WI-FI OPERATION FOR PERSONAL AREA NETWORK DEVICES

(71) Applicant: QUALCOMM Incorporated, San Diego, CA (US)

(72) Inventors: Ahmed Ragab ELSHERIF, San Jose, CA (US); Laurent WOJCIESZAK, Belfast (GB)

(21) Appl. No.: 19/070,521

(22) Filed: Mar. 4, 2025

Related U.S. Application Data
(60) Provisional application No. 63/562,138, filed on Mar. 6, 2024.

(51) Int. Cl. H04W 36/36; H04W 28/02; H04W 36/00; H04W 36/30; H04W 60/06

(52) U.S. Cl. CPC H04W 36/36; H04W 28/0289; H04W 36/00222; H04W 36/30; H04W 60/06

(57) ABSTRACT

This disclosure provides methods, components, devices and systems for Bluetooth assisted Wi-Fi operations for personal area network devices. Some aspects more specifically relate to a personal audio device communicating via a Bluetooth communication link while initiating a connection to an AP or a personal wireless communication device. For example, the personal audio device may receive a request to switch audio communications from a first wireless communication link with the personal wireless communication device to a second wireless communication link, such as a Bluetooth wireless communication link. The request to switch may be in response to a triggering operation, including channel switching, channel scanning, and/or roaming. The personal audio device may communicate via the second wireless communication link during the triggering operation.

### CROSS REFERENCE

The present Application for Patent claims the benefit of U.S. Provisional Patent Application No. 63/562,138 by ELSHERIF et al., entitled “BLUETOOTH ASSISTED WI-FI OPERATION FOR PERSONAL AREA NETWORK DEVICES” filed Mar. 6, 2024, assigned to the assignee hereof, and expressly incorporated by reference herein.

### TECHNICAL FIELD

This disclosure relates generally to wireless communication and, more specifically, to Bluetooth assisted Wi-Fi operations for personal area network devices.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

Wireless communication devices may communicate in an extended personal area network (XPAN) via peer to peer (P2P) wireless communication links, such as 2.4 GHz, 5 GHz or 6 GHz wireless communication links. For example, a personal wireless communication device such as a handset or desktop computer may communicate with a personal audio device such as XPAN-capable earbuds, earbuds, a headset, or AR, VR, or XR glasses. The communication links of the XPAN may be 2.4 GHz, 5 GHz, or 6 GHz wireless communication links for reduced latency and/or high throughput applications, such as streaming audio for gaming applications, music, or voice calls. In XPAN, audio may be streamed from a personal wireless communication device to a personal audio device(s) using a Wi-Fi link between the personal wireless communication device and the personal audio device while the personal wireless communication device is in communication with an AP over an infra Wi-Fi link. In some examples, the physical range of the XPAN wireless communications link between the personal wireless communication device and the personal audio device(s) may be limited.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a first wireless communication device is described. The method may include communicating, with a second wireless communication device via a first wireless communication link associated with a first wireless protocol, a first set of audio data associated with an application for the first wireless communication device, receiving, from the second wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol, and communicating, with the second wireless communication device via the second wireless communication link during the triggering operation, a second set of audio data associated with the application in response to the request to switch.

Another innovative aspect of the subject matter described in this disclosure can be implemented in a first wireless communication device for wireless communication is described. The first wireless communication device may include a processing system that includes processor circuitry and memory circuitry that stores code. The processing system may be configured to cause the first wireless communication device to communicate, with a second wireless communication device via a first wireless communication link associated with a first wireless protocol, a first set of audio data associated with an application for the first wireless communication device, receive, from the second wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol, and communicate, with the second wireless communication device via the second wireless communication link during the triggering operation, a second set of audio data associated with the application in response to the request to switch.

Another innovative aspect of the subject matter described in this disclosure can be implemented in a first wireless communication device for wireless communication is described. The first wireless communication device may include means for communicating, with a second wireless communication device via a first wireless communication link associated with a first wireless protocol, a first set of audio data associated with an application for the first wireless communication device, means for receiving, from the second wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol, and means for communicating, with the second wireless communication device via the second wireless communication link during the triggering operation, a second set of audio data associated with the application in response to the request to switch.

Another innovative aspect of the subject matter described in this disclosure can be implemented in a non-transitory computer-readable medium storing code for wireless communication is described. The code may include instructions executable by one or more processors to communicate, with a second wireless communication device via a first wireless communication link associated with a first wireless protocol, a first set of audio data associated with an application for the first wireless communication device, receive, from the second wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol, and communicate, with the second wireless communication device via the second wireless communication link during the triggering operation, a second set of audio data associated with the application in response to the request to switch.

In some examples of the method, first wireless communication devices, and non-transitory computer-readable medium described herein, the triggering operation includes a roaming operation and the method, apparatuses, and non-transitory computer-readable medium may include further operations, features, means, or instructions for monitoring one or more channels associated with the first wireless communication link and transmitting, via the first wireless communication link, a roaming indication in response to a channel quality of the one or more channels associated with the first wireless communication link falling below a threshold channel quality, where the request to switch audio communications may be received in response to the roaming indication.

Some examples of the method, first wireless communication devices, and non-transitory computer-readable medium described herein may further include operations, features, means, or instructions for receiving, from a third wireless communication device and in accordance with the roaming indication, an indication of an internet protocol (IP) address for the first wireless communication device while communicating the second set of audio data with the second wireless communication device via the second wireless communication link.

Some examples of the method, first wireless communication devices, and non-transitory computer-readable medium described herein may further include operations, features, means, or instructions for transmitting the IP address to the second wireless communication device in response to the indication of the IP address while communicating the second set of audio data with the second wireless communication device via the second wireless communication link.

In some examples of the method, first wireless communication devices, and non-transitory computer-readable medium described herein, the triggering operation includes a roaming operation and the method, apparatuses, and non-transitory computer-readable medium may include further operations, features, means, or instructions for monitoring one or more channels associated with the first wireless communication link and transmitting, via the first wireless communication link, a roaming indication in response to a congestion level of the one or more channels associated with the first wireless communication link exceeding a threshold congestion level, where the request to switch audio communications may be received in response to the roaming indication.

In some examples of the method, first wireless communication devices, and non-transitory computer-readable medium described herein, the triggering operation includes a roaming operation and the method, apparatuses, and non-transitory computer-readable medium may include further operations, features, means, or instructions for transmitting a roaming request message including audio destination information, the audio destination information indicating the second wireless protocol for audio communications associated with the application.

In some examples of the method, first wireless communication devices, and non-transitory computer-readable medium described herein, the first wireless communication link includes a peer to peer communication link and the second wireless communication link includes a wireless local area network (WLAN) communication link and the method, apparatuses, and non-transitory computer-readable medium may include further operations, features, means, or instructions for communicating, while communicating the second set of audio data with the second wireless communication device via the second wireless communication link, a third set of audio data associated with the application via the first wireless communication link.

Some examples of the method, first wireless communication devices, and non-transitory computer-readable medium described herein may further include operations, features, means, or instructions for performing the triggering operation while communicating the second set of audio data with the second wireless communication device via the second wireless communication link, where the triggering operation includes a channel scanning operation, a channel switching operation, a roaming operation, or any combination thereof.

In some examples of the method, first wireless communication devices, and non-transitory computer-readable medium described herein, communicating the first set of audio data may include operations, features, means, or instructions for communicating the first set of audio data according to a first set of encoding parameters.

In some examples of the method, first wireless communication devices, and non-transitory computer-readable medium described herein, communicating the second set of audio data may include operations, features, means, or instructions for communicating the second set of audio data according to a second set of encoding parameters different from the first set of encoding parameters and corresponding to a reduced bit rate or increased latency relative to the first set of encoding parameters.

In some examples of the method, first wireless communication devices, and non-transitory computer-readable medium described herein, the first wireless protocol includes one of wireless location area network (WLAN) protocol or BLUETOOTH protocol and the second wireless protocol includes one of the WLAN protocol or the BLUETOOTH protocol.

Another innovative aspect of the subject matter described in this disclosure can be implemented in a method for wireless communication by a second wireless communication device is described. The method may include communicating, with a first wireless communication device via a first wireless communication link associated with a first wireless protocol, a first set of audio data associated with an application for the first wireless communication device, transmitting, to the first wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol, and communicating, with the first wireless communication device via the second wireless communication link during the triggering operation, a second set of audio data associated with the application in response to the request to switch.

Another innovative aspect of the subject matter described in this disclosure can be implemented in a second wireless communication device for wireless communication is described. The second wireless communication device may include a processing system that includes processor circuitry and memory circuitry that stores code. The processing system may be configured to cause the second wireless communication device to communicate, with a first wireless communication device via a first wireless communication link associated with a first wireless protocol, a first set of audio data associated with an application for the first wireless communication device, transmit, to the first wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol, and communicate, with the first wireless communication device via the second wireless communication link during the triggering operation, a second set of audio data associated with the application in response to the request to switch.

Another innovative aspect of the subject matter described in this disclosure can be implemented in a second wireless communication device for wireless communication is described. The second wireless communication device may include means for communicating, with a first wireless communication device via a first wireless communication link associated with a first wireless protocol, a first set of audio data associated with an application for the first wireless communication device, means for transmitting, to the first wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol, and means for communicating, with the first wireless communication device via the second wireless communication link during the triggering operation, a second set of audio data associated with the application in response to the request to switch.

Another innovative aspect of the subject matter described in this disclosure can be implemented in a non-transitory computer-readable medium storing code for wireless communication is described. The code may include instructions executable by one or more processors to communicate, with a first wireless communication device via a first wireless communication link associated with a first wireless protocol, a first set of audio data associated with an application for the first wireless communication device, transmit, to the first wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol, and communicate, with the first wireless communication device via the second wireless communication link during the triggering operation, a second set of audio data associated with the application in response to the request to switch.

Some examples of the method, second wireless communication devices, and non-transitory computer-readable medium described herein may further include operations, features, means, or instructions for monitoring one or more channels associated with the first wireless communication link, where the request to switch audio communications may be transmitted in response to a channel quality of the one or more channels associated with the first wireless communication link falling below a threshold channel quality detected during the monitoring of the one or more channels.

Some examples of the method, second wireless communication devices, and non-transitory computer-readable medium described herein may further include operations, features, means, or instructions for monitoring one or more channels associated with the first wireless communication link, where the request to switch audio communications may be transmitted in response to a congestion level of the one or more channels associated with the first wireless communication link falling below a threshold congestion level detected during the monitoring of the one or more channels.

In some examples of the method, second wireless communication devices, and non-transitory computer-readable medium described herein, and the method, apparatuses, and non-transitory computer-readable medium may include further operations, features, means, or instructions for receive a roaming indication, where the request to switch audio communications may be transmitted in response to the roaming indication.

In some examples of the method, second wireless communication devices, and non-transitory computer-readable medium described herein, the roaming indication may be received from the first wireless communication device, from one or more components of the second wireless communication device, or both.

In some examples of the method, second wireless communication devices, and non-transitory computer-readable medium described herein, the triggering operation includes a roaming operation and the method, apparatuses, and non-transitory computer-readable medium may include further operations, features, means, or instructions for receiving, from the first wireless communication device, a roaming request message including audio destination information, the audio destination information indicating the second wireless protocol for audio communications associated with the application.

Some examples of the method, second wireless communication devices, and non-transitory computer-readable medium described herein may further include operations, features, means, or instructions for receiving, from the first wireless communication device, an internet protocol (IP) address of the first wireless communication device while communicating the second set of audio data with the first wireless communication device via the second wireless communication link.

Some examples of the method, second wireless communication devices, and non-transitory computer-readable medium described herein may further include operations, features, means, or instructions for performing the triggering operation while communicating the second set of audio data with the first wireless communication device via the second wireless communication link, where the triggering operation includes a channel scanning operation, a channel switching operation, a roaming operation, or any combination thereof.

In some examples of the method, second wireless communication devices, and non-transitory computer-readable medium described herein, the first wireless communication link includes a peer to peer communication link and the second wireless communication link includes a WLAN communication link and the method, apparatuses, and non-transitory computer-readable medium may include further operations, features, means, or instructions for communicating, while communicating the second set of audio data with the first wireless communication device via the second wireless communication link, a third set of audio data associated with the application via the first wireless communication link.

In some examples of the method, second wireless communication devices, and non-transitory computer-readable medium described herein, communicating the first set of audio data may include operations, features, means, or instructions for communicating the first set of audio data according to a first set of encoding parameters.

Some examples of the method, second wireless communication devices, and non-transitory computer-readable medium described herein may further include operations, features, means, or instructions for communicating the second set of audio data according to a second set of encoding parameters different from the first set of encoding parameters and corresponding to a reduced bit rate relative to the first set of encoding parameters.

In some examples of the method, second wireless communication devices, and non-transitory computer-readable medium described herein, the first wireless protocol includes one of wireless location area network (WLAN) protocol or BLUETOOTH protocol and the second wireless protocol includes one of the WLAN protocol or the BLUETOOTH protocol.

### BRIEF DESCRIPTION OF THE DRAWINGS

FIG. 1 shows a pictorial diagram of an example wireless communication network.

FIGS. 2a and 2b show examples of extended personal area network (XPAN) scenarios that support Bluetooth assisted Wi-Fi operations for personal area network devices.

FIG. 3 shows an example of an XPAN scenario that supports Bluetooth assisted Wi-Fi operations for personal area network devices.

FIG. 4 shows an example of a transition in an XPAN scenario that supports Bluetooth assisted Wi-Fi operations for personal area network devices.

FIGS. 5 and 6 show examples of process flows that supports Bluetooth assisted Wi-Fi operations for personal area network devices.

FIG. 7 shows an example of an XPAN scenario that supports Bluetooth assisted Wi-Fi operations for personal area network devices.

FIG. 8 shows an example of a transition in an XPAN scenario that supports Bluetooth assisted Wi-Fi operations for personal area network devices.

FIGS. 9 through 11 show examples of process flows that support Bluetooth assisted Wi-Fi operations for personal area network devices.

FIG. 12 shows a block diagram of an example wireless communication device that supports Bluetooth assisted Wi-Fi operations for personal area network devices.

FIG. 13 shows a block diagram of an example wireless communication device that supports Bluetooth assisted Wi-Fi operations for personal area network devices.

FIGS. 14 through 17 show flowcharts illustrating example processes performable by or at a first wireless communication device that supports Bluetooth assisted Wi-Fi operations for personal area network devices.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

A wireless communication device, such as a station (STA) in a wireless local area network (WLAN), may communicate with an access point (AP) via a channel, such as a 2.4 gigahertz (GHz) (also referred to as 2 GHz), 5 GHz, or 6 GHz wireless communication link. The wireless communication device also may communicate with wireless communication devices such as personal audio devices, in an extended personal area network (XPAN) via peer to peer (P2P) wireless communication links, such as 2.4 GHz, 5 GHz or 6 GHz wireless communication links. For example, a personal wireless communication device such as a handset or desktop computer may communicate with a personal audio device such as XPAN-capable earbuds; a headset; AR, VR, or XR glasses; or a gaming controller (such as in communication with a gaming console). A personal audio device also may be a STA. Additionally, the personal audio device may be an audio/visual (A/V) device capable of providing mixed format multimedia (such as in addition to audio). The communication links of the XPAN may be 2.4 GHz, 5 GHz, or 6 GHz wireless communication links for reduced latency and/or high throughput applications, such as streaming audio for gaming applications, music, or voice calls.

In XPAN, audio is streamed from a personal wireless communication device to a personal audio device(s) using a Wi-Fi link (such as a 2.4 GHz, 5 GHz or 6 GHz wireless communication links) between the personal wireless communication device and the personal audio device while the personal wireless communication device is in communication with an AP over an infra Wi-Fi link. The physical range of the XPAN wireless communications link between the personal wireless communication device and the personal audio device(s) may be limited, and accordingly, the link quality may deteriorate, which may affect the audio streaming quality, if the user of the personal audio device moves away from the personal wireless communication device.

The range of a personal audio device connected to a personal wireless communication device may be extended via enabling the personal audio device to connect to and communicate with the personal wireless communication device via an AP. An AP may have a larger range than a personal wireless communication device, and accordingly, an AP may be used to stream audio to the personal audio device when the direct P2P link quality between the personal audio device and the personal wireless communication device is below a threshold. Communicating between the personal wireless communication device and the personal audio device through an AP increases latency as compared to direct P2P communications between the personal wireless communication device and the personal audio device, and accordingly, the personal audio device may be biased to communicate with the personal wireless communication device via a direct XPAN link (such as a P2P wireless communication link) when possible. To reduce latency and packet loss associated with transitions between communicating with the personal wireless communication device directly and via the AP, the personal audio device may communicate (such as receive data) via a Bluetooth communication link while initiating a connection to an AP. For example, before breaking a P2P link with the wireless communication device, the personal audio device may switch data to be received via the Bluetooth communication link, associate with an AP, and receive an IP address from the AP, which the personal audio device may then share with the personal wireless communication device. Once the personal audio device is connected with the AP, the personal audio device may transmit a disassociation message to the personal wireless communication device, and may communicate with the personal wireless communication device via the connection with the AP. Such seamless transitions reduce latency and avoid packet loss, as compared to transitions where data may not be received during establishment of a new wireless communication link. When communicating with the personal wireless communication device via an AP, the personal audio device may transition back to a direct P2P wireless communications link with the personal wireless communication device if the personal audio device determines that a link quality of the P2P wireless communication link satisfies a utility function. During the transition from the AP to the direct P2P wireless communications link, the personal audio device may communicate via a Bluetooth communication link. That is, during transitions between wireless communication links, the personal audio device may communicate over a Bluetooth wireless communication link such that one or more packets may not be lost during the transition. Additionally, or alternatively, the personal wireless communication device may adjust audio parameters (such as a coding bit rate and/or an audio latency) in accordance with the switch to or from the Bluetooth wireless communication link. For example, the personal wireless communication device may transmit audio data to the personal audio device with first audio parameters for a first wireless communication link (such as Wi-Fi or P2P) associated with a first wireless technology, or with second audio parameters for the Bluetooth wireless communication link associated with a second wireless technology.

Particular aspects of the subject matter described in this disclosure can be implemented to realize one or more of the following potential advantages. In some examples, the range of XPAN communications may be extended by enabling a personal audio device and a personal wireless communication device to communicate via one or more APs. Accordingly, XPAN range may be increased to whole building or whole office scenarios, for example, in scenarios where a building or office is served by a mesh network of APs. Additionally, or alternatively, latency associated with transitions may be reduced by communicating via the Bluetooth communication link during a transition between a first wireless communication link and a second communication link. For example, before breaking a P2P link with a personal wireless communication device, a personal audio device may switch data to be received via the Bluetooth communication link and associate with and establish a wireless communication link with an AP. Once the personal audio device is connected with the AP, the personal audio device may transmit a disassociation message to the personal wireless communication device and may communicate with personal wireless communication device via the connection with the AP. Similarly, before breaking a connection with an AP to connect with the personal wireless communication device via a P2P wireless communication link or to connect with a different AP, the personal audio device switches the data to be received via the Bluetooth communication link and associates with and establishes communications with the personal wireless communication device or the different AP, thereby reducing latency associated with such transitions. Additionally, or alternatively, as communications between the personal wireless communication device and the personal audio device through an AP (or through multiple APs) increases latency as compared to direct P2P communications between the personal wireless communication device and the personal audio device, the personal audio device may be biased to communicate with the personal wireless communication device via a direct XPAN link when possible.

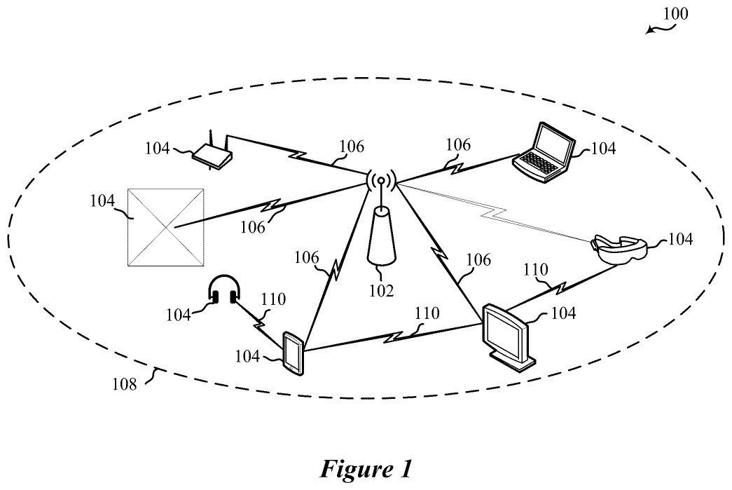

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds (such as XPAN-capable earbuds, or earbuds capable of receiving an audio stream or other communications form another device via a Wi-Fi link), other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

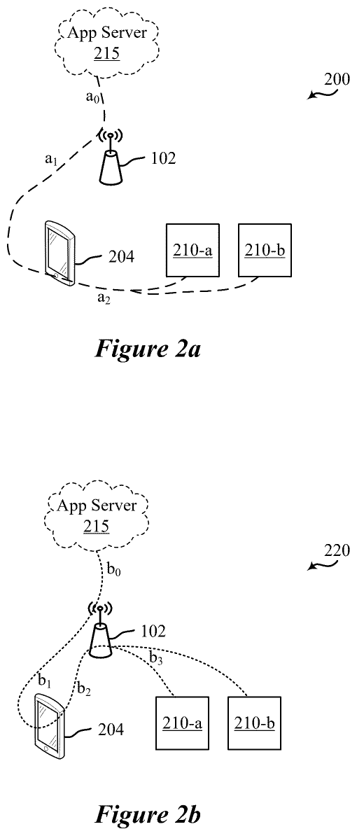

FIGS. 2a and 2b illustrate an example of XPAN scenarios 200 and 220, respectively, that include a personal wireless communication device 204, an AP 102, an application server 215, and personal audio devices 210-a and 210-b. A personal wireless communication device 204 may be a station 104 as described with reference to FIG. 1. For example, a personal wireless communication device 204 may be a handset, a laptop computer, or a desktop computer. The personal wireless communication device may operate according to one or more radio configurations, including High Band Simultaneous (HBS), DBS, or Single Radio. The personal audio devices 210-a and 210-b may be another example of a STA 104 as described with reference to FIG. 1. For example, the personal audio devices 210-a and 210-b may be XPAN-capable earbuds; a headset; headphones; AR, VR, or XR glasses; or a gaming controller (such as in communication with a gaming console). The AP 102 may be an example of an AP 102 described with reference to FIG. 1.

XPAN may be applied in use cases of streaming lossless audio or voice calls to personal audio devices such as personal audio devices 210-a and 210-b. For example, in XPAN scenarios, the personal audio devices 210-a and 210-b may be XPAN-capable earbuds; a headset; headphones; AR, VR, or XR glasses; or a gaming controller (such as in communication with a gaming console). As described herein, XPAN may enable whole or home building coverage for audio streaming. In a whole home or building coverage scenario, a user may leave a personal wireless communication device 204 behind and walk around with personal audio devices 210-a and 210-b while the personal audio devices 210-a and 210-b are still connected to the network, enabling uninterrupted listening to audio such as music, podcasts, or audio books, or enabling uninterrupted voice calls. The techniques described herein enable seamless transitions between wireless communication links for XPAN. Example supported audio formats may include 48K/96K/192K lossless or lossy audio streaming, voice calls, music, and voice assistant. For example, in an office environment a user may be at a cubicle while on a conference call and may walk to a break room while leaving the personal wireless communication device 204 at her desk without disruption of the conference call.

In the example XPAN scenarios 200 and 220 of FIGS. 2a and 2b, an application may run on the personal wireless communication device 204 that streams audio (such as for music, video, podcasts, audio books, or voice calls). The data for the application may be served to the personal wireless communication device 204 from an application server 215. Two routes, shown as “a” and “b,” for streaming audio from the personal wireless communication device 204 to the personal audio devices 210-a and 210-b are possible, as illustrated in the example of FIGS. 2a and 2b, respectively.

In the example XPAN scenario 200, in a first route, shown as the “a” route, audio data may be streamed over a P2P wireless communication link between the personal wireless communication device 204 and the personal audio devices 210-a and 210-b. For example, audio data is streamed from the application server 215 to the AP 102 via a wireless communication link a0, from the AP 102 to the personal wireless communication device 204 via a wireless communication link a1, and from the personal wireless communication device 204 to the personal audio devices 210-a and 210-b via a P2P wireless communication link a2.

In the example XPAN scenario 220, in a second route, shown as the “b” route, audio data may be streamed from the personal wireless communication device 204 to the AP 102 and then from the AP 102 to the personal audio devices 210-a and 210-b. For example, audio data is streamed from the application server 215 to the AP 102 via a wireless communication link b0, from the AP 102 to the personal wireless communication device 204 via a wireless communication link b1, from the personal wireless communication device 204 back to the AP 102 via a wireless communication link b2, and from the AP 102 to the personal audio devices 210-a and 210-b via a wireless communication link b3.

The “b” route may be associated with a higher latency due to the multiple links as compared to the P2P link of the “a” route, but the “b” route may have a larger range, as an AP 102 may have a larger transmission range than a personal wireless communication device 204. In some examples, the XPAN scenario 200 and the XPAN scenario 220 may be combined. For example, the first route and the second route of the XPAN scenario 200 and the XPAN scenario 220 may be combined for an online streaming/voice over internet protocol (IP)/voice assistant scenario where the application server 215 serves audio data to an application running on the personal wireless communication device 204 via the AP 102.

As described herein, the personal audio devices 210-a and 210-b may receive audio data from the personal wireless communication device 204 via a Bluetooth communication link during a transition between the example XPAN scenario 200 and the example XPAN scenario 220. For example, the personal wireless communication device 204 may stream audio data to the personal audio devices 210-a and 210-b via the Bluetooth communication link (such as a Bluetooth Low Energy (BLE) link) such that one or more packets may not be dropped during the transition.

For example, a Wi-Fi subsystem (SS) of the personal wireless communication device 204 may determine whether a trigger operation may be addressed via Wi-Fi. As an example, the Wi-Fi SS may determine whether the trigger operation may be addressed via Wi-Fi in accordance with a capability of a Wi-Fi chip and/or concurrencies. Wi-Fi SS determines whether channel scanning can be conducted without impacting ongoing XPAN music streaming. For example, the Wi-Fi SS may determine whether, as an example, channel scanning, may be conducted without impacting music streaming, such as by going off-channel or by running scanning in parallel on another radio (such as HBS or DBS radio).

The trigger operation may include one or more of scanning (such as when Wi-Fi channel quality is below a threshold quality), channel switching, roaming and/or connection to an AP (such as the AP 102 or another AP), or the like. In some examples, the trigger operation may be related to a channel quality level and/or a channel congestion level. That is, the personal wireless communication device 204 may perform the trigger operation based on the channel quality level being below a threshold, the channel congestion level being above a threshold, or both. In some examples, the threshold channel quality and/or the threshold channel congestion may be associated with a music streaming quality. Additionally, or alternatively, the personal audio devices 210-a and 210-b may perform the trigger operation based on roaming. That is, a channel quality, a channel congestion, or both may satisfy a threshold based on the roaming.

The Wi-Fi SS may indicate, to an audio encoder (such as of an application layer) to switch the personal audio devices 210-a and 210-b to Bluetooth. The audio encoder may adjust audio characteristics (such as drop a coding bit rate and/or increase audio latency). As an example, the audio encoder may decrease an audio quality from 96K/192K lossless streaming to a lower quality level that associated with a Bluetooth PHY rate. In accordance with the switch to Bluetooth during the trigger condition, the personal communication device may support seamless music streaming over Bluetooth. In other words, a Wi-Fi operation (such as scanning, channel switch, roaming/connection to another AP or the like may occur in parallel to the Bluetooth streaming over Wi-Fi. After the Wi-Fi operation ends, the Wi-Fi SS may indicate the end of the operation to the audio encoder which may re-adjust audio characteristics accordingly (such as increases coding bit rate and/or decrease audio latency).

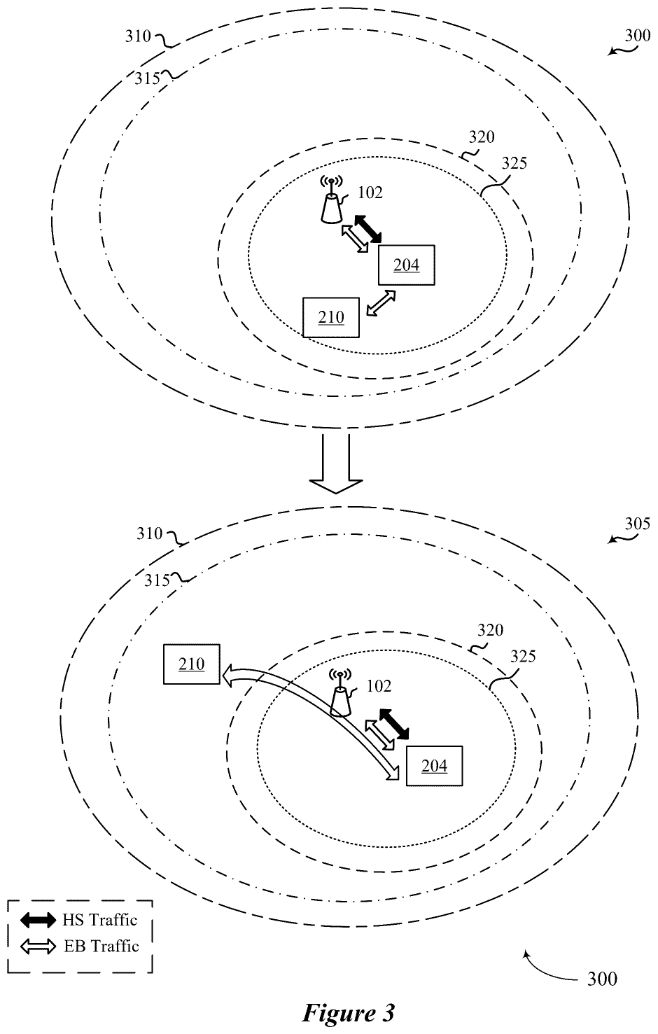

FIG. 3 illustrates an example in an XPAN scenario of a transition between a P2P wireless connection at a first time 300 and a personal audio device-AP connection at a second time 305. The example XPAN scenario illustrated in FIG. 3 includes an AP 102, which may be an example of an AP 102 as described herein, a personal wireless communication device 204, which may be an example of a personal wireless communication device 204 described herein, and a personal audio device 210, which may be an example of a personal audio device 210-a and/or 210-b as described herein. For example, FIG. 3 may illustrate a scenario in which a user of XPAN enabled earbuds (personal audio device 210) moves out of the range of the personal wireless communication device 204. For example, a user of XPAN enabled earbuds may walk away from their desk while leaving their phone (personal wireless communication device 204) at their desk.

The AP 102 may have a 2.4G range 310 and a 5G/6G range 315. As used herein, 2.4G refers to the 2.4 GHz radio frequency band, 5G refers to the 5 GHz radio frequency band, and 6G refers to the 6 GHz radio frequency band. The 2.4G range 310 may be larger than the 5G/6G range 315. The personal wireless communication device 204 may have a 2.4G range 320 and a 5G/6G range 325. The 2.4G range 320 may be larger than the 5G/6G range 325. The AP 102 has a larger range than the personal wireless communication device 204, for example, the 5G/6G range 315 of the AP 102 is larger than the 2.4G range 320 of the personal wireless communication device 204.

Accordingly, at the first time 300, when the personal audio device 210 is within the 5G/6G range of the personal wireless communication device 204, the personal wireless communication device 204 and the personal audio device 210 may communicate audio data (shown as EB traffic) via a direct P2P wireless communication link. The personal wireless communication device 204 may communicate audio data for relaying onto or from the personal audio device 210 (shown as EB traffic) and other data specific to the personal wireless communication device 204 (shown as HS traffic) with the AP 102.

At the second time 305, when the personal audio device 210 is outside of the range of the personal wireless communication device 204 (both the 2.4G range 320 and the 5G/6G range 325), the personal audio device 210 and the personal wireless communication device 204 may communicate audio data via the AP 102. Accordingly, between the first time 300 and the second time 305, the personal audio device 210 may transition from a personal audio device-personal wireless communication device connection scenario to a personal audio device-AP connection scenario.

During the transition from the personal audio device-personal wireless communication device connection scenario to the personal audio device-AP connection scenario, the personal audio device 210 may receive audio data from the personal wireless communication device 204 via a Bluetooth communication link. For example, the personal wireless communication device 204 may stream audio data to the personal audio device 210 via the Bluetooth communication link (such as a BLE link) such that one or more packets may not be dropped during the transition.

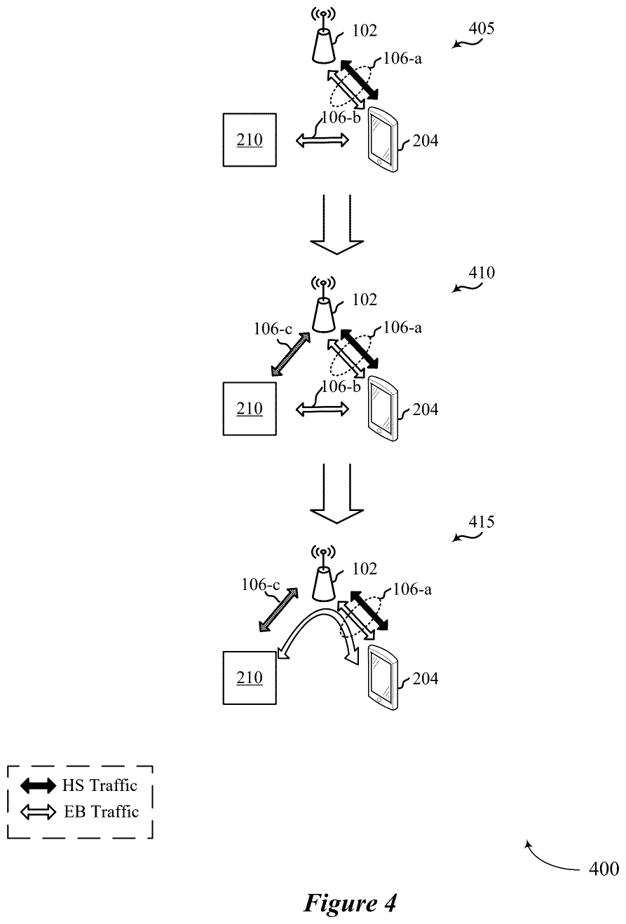

FIG. 4 illustrates an example of a transition in an XPAN scenario 400 between a P2P wireless connection and a personal audio device-AP connection. The XPAN scenario 400 includes the AP 102, the personal wireless communication device 204, and the personal audio device 210 described with reference to FIG. 3. As the transition illustrated in the XPAN scenario 400 exchanges data over BLE during establishment of a connection between the personal audio device 210 and the AP 102 and the P2P connection between the personal audio device 210 and the personal wireless communication device 204, the transition may reduce latency and packet loss as compared to a transition from a P2P connection to an AP connection in which the connection to the AP is not established prior to breaking the P2P connection and/or in which data is not exchanged during the transition.

At 405, the personal wireless communication device 204 communicates audio data for relaying onto or from the personal audio device 210 (shown as EB traffic) and other data specific to the personal wireless communication device 204 (shown as HS traffic) with the AP 102 via a communication link 106-a. At 405, the personal wireless communication device 204 communicates audio data (shown as EB traffic) via a direct P2P wireless communication link 106-b.

The personal audio device 210 monitors the link quality of the P2P wireless communication link 106-b. If the P2P wireless communication link 106-b drops below a threshold (LQ_{AssocAP}) the personal audio device 210 may request the most recent channel scan results from the personal wireless communication device 204. In response, the personal wireless communication device 204 may share the most recent scan results with the BSSID of the associated AP (the AP 102), the channel of the AP 102, and capabilities of the AP 102. In some examples, if the most recent scan results are older than a threshold, the personal wireless communication device 204 may perform a channel scan in response to the request from the personal audio device 210, and the personal wireless communication device 204 may share the results of the newly performed channel scan with the personal audio device 210. The personal audio device 210 may calculate a utility function for the P2P connection versus APs in the vicinity of the personal audio device 210.

At 410, if the personal audio device 210 determines that a connection to the AP 102 provides a better utility function, the personal audio device 210 begins an association/authentication or connection process with the AP 102. In some examples, the association/authentication or connection process may involve a security key exchange or dynamic host configuration protocol (DHCP) server negotiation with the candidate AP (such as the AP 102). The personal audio device 210 may transition from the P2P connection to the AP connection via BLE. For example, the personal audio device 210 may switch data to be received via a Bluetooth wireless communication link, and connect to the AP at 410 while receiving the data over Bluetooth wireless communication link.

The personal audio device 210 obtains an IP address from the AP 102, and shares the IP address and/or MAC address with the personal wireless communication device 204. Accordingly, the personal audio device 210 establishes a wireless communication link 106-c with the AP 102, and has dual connectivity via the wireless communication link 106-c and the wireless communication link 106-b. The personal wireless communication device 204 may look up the MAC address of the personal audio device 210 using the address resolution protocol (ARP), and the personal wireless communication device 204 may switch the BT control path for communications with the personal audio device 210 over transmission control protocol (TCP). In some examples, the personal audio device 210 may share the IP addresses and MAC addresses of the personal audio device 210 with the personal wireless communication device 204.

If the link quality of the P2P wireless communication link 106-b drops below a second threshold (LQ_{roamAP}), the personal audio device 210 may transmit a roaming indication or a roaming request to the personal wireless communication device 204. In response to the roaming indication or roaming request, the personal wireless communication device 204 may increase audio latency to handle latency across the network, may reduce the audio bit rate, and/or may increase audio latency to handle end to end latency across the network.

At 415, the personal wireless communication device 204 switches audio data from ethernet to User Datagram Protocol (UDP), and the personal wireless communication device 204 transfers audio data to the personal audio device 210 via the AP 102 (via the wireless communication link 106-a and the wireless communication link 106-c). In some examples, in response to the roaming indication, the personal wireless communication device 204 may switch BT control from BLE to TCP over the AP 102. In some examples, in response to the roaming indication, the personal wireless communication device 204 and the personal audio device may disassociate/break the P2P wireless communication link 106-b and the personal wireless communication device 204 may forward data to the personal audio device 210 through the AP 102 using the IP and MAC addresses of the personal audio device 210.

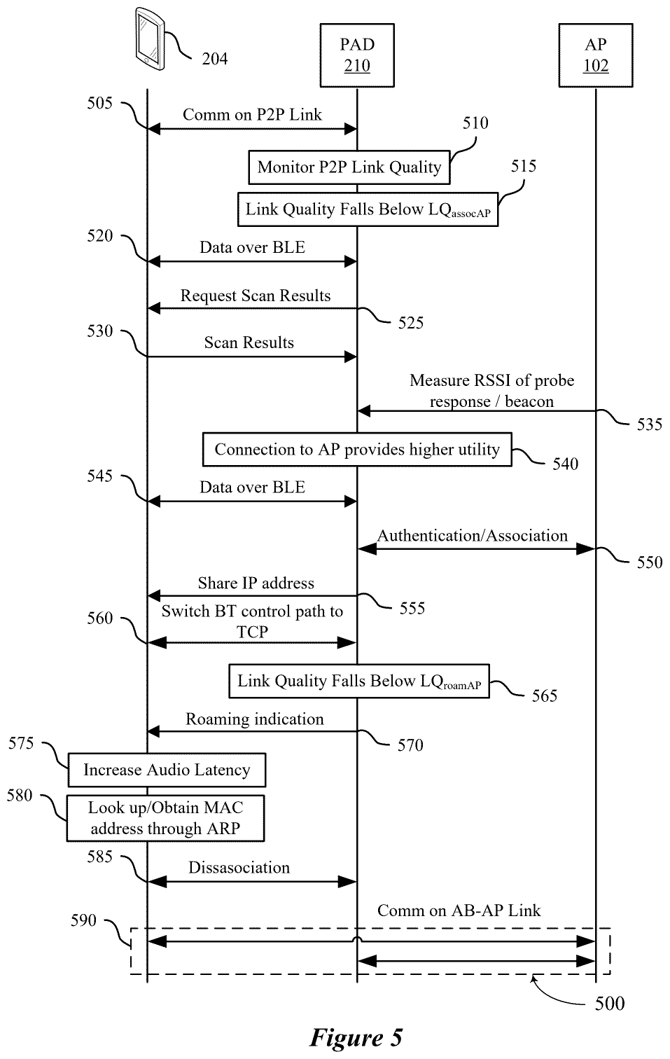

FIG. 5 illustrates an example of a process flow 500 of a transition in an XPAN scenario between a P2P wireless connection and a personal audio device-AP connection. The process flow 500 includes the AP 102, the personal wireless communication device 204, and the personal audio device 210 described with reference to FIG. 2. In the following description of the process flow 500, the operations between the AP 102, the personal wireless communication device 204, and the personal audio device 210 may be transmitted in a different order than the example order shown, or the operations performed by the AP 102, the personal wireless communication device 204, and the personal audio device 210 may be performed in different orders or at different times. Some operations also may be omitted from the process flow 500, and other operations may be added to the process flow 500. As the transition illustrated in the process flow 500 exchanges data over BLE during establishment of a connection between the personal audio device 210 and the AP 102, the transition illustrated in the process flow 500 may reduce latency and packet loss as compared to a transition from a P2P connection to an AP connection in which the connection to the AP is not established prior to breaking the P2P connection and/or in which data is not exchanged during the transition.

At 505, the personal audio device 210 may communicate with the personal wireless communication device 204 via a P2P wireless communication link (such as the P2P wireless communication link 106-b of FIG. 4). In some examples, the P2P wireless communication link may be an example of an XPAN soft AP (SAP) active link. At 510, the personal audio device 210 may monitor the link quality of the P2P wireless communication link. At 515, the personal audio device 210 may determine that the link quality of the P2P wireless communication link falls below the threshold LQ_{AssocAP}. In response to determining that the link quality falls below the threshold LQ_{AssocAP}, the personal audio device 210 may transmit a roaming request to the personal wireless communication device 204. The personal wireless communication device 204 may reduce an audio bit rate (such as in accordance with a BLE wireless communication link) and/or enable a LE link (such as establish a continuous isochronous stream (CIS)). In some examples, in response to enabling the LE link, the personal wireless communication device 204 may transmit a LE Asynchronous Connection-oriented Logical transport (ACL) connect request to the personal audio device 210. In response to the LE ACL connect request, the personal audio device 210 may transmit an audio bearer switch request or response. In other words, in response to determining that the link quantity falls below the threshold LQ_{AssocAP}, the personal audio device 210 may switch an audio bearer to BLE.

In some examples, at 520 and after switching the audio bearer to BLE, the personal audio device 210 may exchange data with the personal wireless communication device 204 via a BLE wireless communication link. Additionally, or alternatively, the personal wireless communication device 204 may exchange data with the personal audio device 210 over the P2P wireless communication link (such as over Wi-Fi). In some examples, at 525, the personal audio device 210 may transmit a request to the personal wireless communication device 204 for the most recent channel scan results. At 530, the personal wireless communication device 204 may transmit the most recent channel scan results to the personal audio device 210. In an alternative example, at 535 and in response to the determination that the link quality of the P2P wireless communication link falls below the threshold LQ_{AssocAP}, the personal audio device 210 may measure the RSSI of a probe response or beacon from the AP 102.

At 540, based on the channel scan results or the measured RSSI of the probe response/beacon, the personal audio device 210 may determine that a connection to the AP 102 provides a higher utility (based on a utility function as described herein) than the P2P wireless communication link. In some examples, if there is a second personal audio device (such as a second earbud), the personal audio device 210 may share the target AP 102 with the second personal audio device.

At 545, the personal audio device 210 may exchange data with the personal wireless communication device 204 via the BLE wireless communication link. While the personal audio device 210 receives data via the BLE wireless communication link and at 550, the personal audio device 210 may perform an association/authentication procedure with the AP 102. In some examples, the personal audio device 210 may exchange security keys with the AP 102. At 555, the personal audio device 210 may share, with the personal wireless communication device 204, an IP address for the personal audio device 210 received during the association/authentication procedure. At 560, the personal wireless communication device 204 may switch the BT control path for communications with the personal audio device 210 over TCP.

At 565, the personal audio device 210 may determine that the link quality of the P2P wireless communication link 106b drops below a second threshold (LQ_{roamAP}). At 570, in response to the link quality of the P2P wireless communication link dropping below the second threshold (LQ_{roamAP}), the personal audio device 210 may transmit a roaming indication to the personal wireless communication device 204. At 575, in response to the roaming indication, the personal wireless communication device 204 may increase audio latency. At 580, in response to the roaming indication, the personal wireless communication device 204 may look up the MAC address of the personal audio device 210 or may obtain the MAC address of the personal audio device 210 through ARP. In some examples, in response to the roaming indication, the personal wireless communication device 204 may switch audio data from ethernet to UDP.

In some examples, at 585, in response to the roaming indication, the personal wireless communication device 204 and the personal audio device may disassociate/break the P2P wireless communication link (the P2P wireless communication link 106-b of FIG. 4).

At 590, the personal wireless communication device 204 and the personal audio device may communicate via the AP 102 (via the wireless communication link 106-a and the wireless communication link 106-c of FIG. 4). For example, the personal wireless communication device 204 may encapsulate audio data in UDP packets.

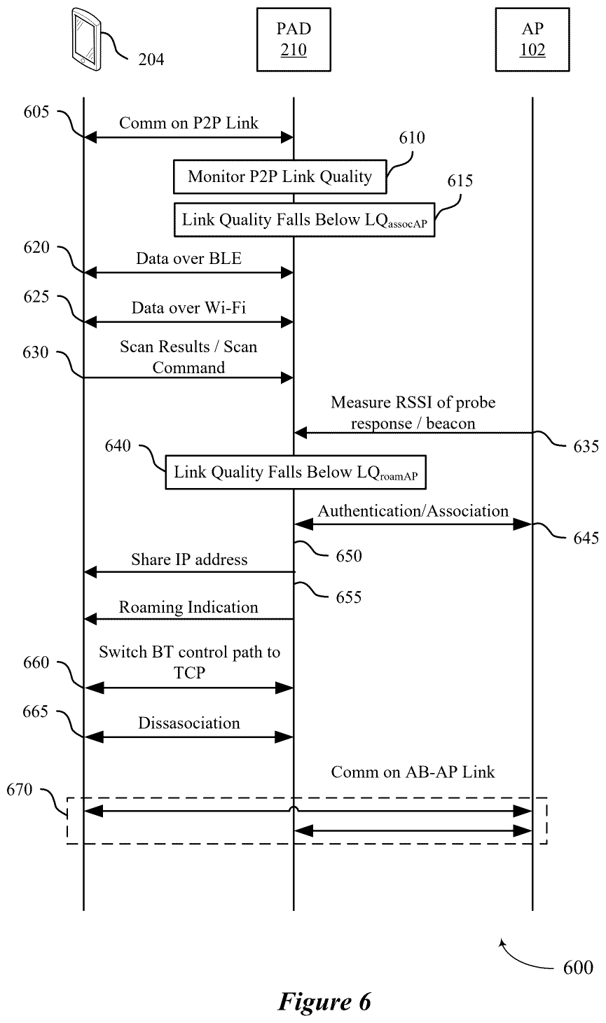

FIG. 6 illustrates an example of a process flow 600 of a transition in an XPAN scenario between a P2P wireless connection at a first time and a personal audio device-AP connection, where the personal wireless communication device assists in the initiation of the transition. The process flow 600 includes the AP 102, the personal wireless communication device 204, and the personal audio device 210 described with reference to FIG. 3. In the following description of the process flow 600, the operations between the AP 102, the personal wireless communication device 204, and the personal audio device 210 may be transmitted in a different order than the example order shown, or the operations performed by the AP 102, the personal wireless communication device 204, and the personal audio device 210 may be performed in different orders or at different times. Some operations also may be omitted from the process flow 600, and other operations may be added to the process flow 600. As the transition illustrated in the process flow 600 exchanges data over BLE during establishment of a connection between the personal audio device 210 and the AP 102, the transition illustrated in the process flow 600 may reduce latency and packet loss as compared to a transition from a P2P connection to an AP connection in which the connection to the AP is not established prior to breaking the P2P connection and/or in which data is not exchanged during the transition.

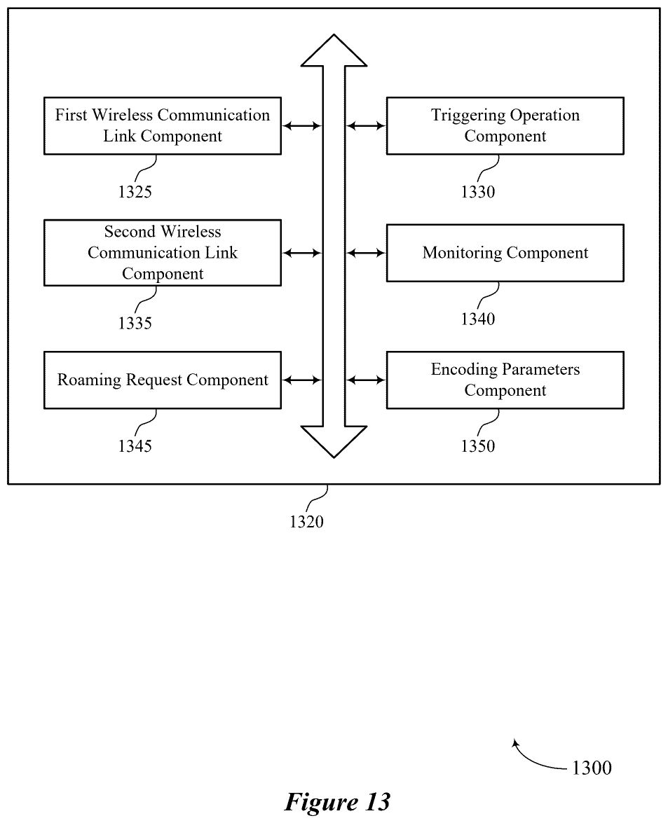

At 605, the personal audio device 210 may communicate with the personal wireless communication device 204 via a P2P wireless communication link (such as the P2P wireless communication link 106-b of FIG. 13). At 610, the personal audio device 210 may monitor the link quality of the P2P wireless communication link. At 615, the personal audio device 210 may determine that the link quality of the P2P wireless communication link falls below the threshold LQ_{AssocAP}. For example, the personal audio device 210 may identify an LE roaming trigger. In some examples, the personal audio device 210, in response to identifying the LE roaming trigger, may transmit a roaming request to the personal wireless communication device 204. The personal wireless communication device 204 may reduce an audio bit rate (such as according to a BLE wireless communication link) and switch an audio bearer to BLE.

At 620, the personal audio device 210 may exchange data with the personal wireless communication device 204 via a BLE wireless communication link. Additionally, or alternatively, at 625, the personal audio device 210 may exchange data with the personal wireless communication device 204 via a Wi-Fi communication link (such as the P2P wireless communication link). That is, the personal audio device 210 may exchange data via both the BLE wireless communication link and the Wi-Fi communication link (such as parallel data on both BLE and Wi-Fi).

At 630, the personal wireless communication device 204 may transmit either an indication of channel scan results at the personal wireless communication device 204 or channel scan command to the personal audio device 210. At 635, in response to a channel scan command, the personal audio device 210 may measure the RSSI of a probe response or beacon from the AP 102.

At 640, the personal audio device 210 may determine that the link quality of the P2P wireless communication link 106-b drops below a second threshold (LQ_{roamAP}). For example, the personal audio device 210 may identify a roaming trigger. In response to the link quality of the P2P wireless communication link dropping below the second threshold, the personal audio device 210 may, at 645, perform an association/authentication procedure with the AP 102. In some examples, the personal audio device 210 may exchange security keys with the AP 102. At 650, the personal audio device 210 may share, with the personal wireless communication device 204, an IP and/or MAC address for the personal audio device 210 received during the association/authentication procedure. At 655, the personal audio device 210 may transmit a roaming indication to the personal wireless communication device 204. In some examples, in response to the roaming suggestion, the personal wireless communication device 204 may switch audio data from ethernet to UDP.

At 660, the personal wireless communication device 204 may switch the BT control path for communications with the personal audio device 210 over TCP. In some examples, at 665, in response to the roaming indication, the personal wireless communication device 204 and the personal audio device may disassociate/break the P2P wireless communication link (the P2P wireless communication link 106-b of FIG. 4).

At 670, the personal wireless communication device 204 and the personal audio device may communicate via the AP 102 (via the wireless communication link 106-a and the wireless communication link 106-c of FIG. 4). For example, the personal wireless communication device 204 may encapsulate audio data in UDP packets.

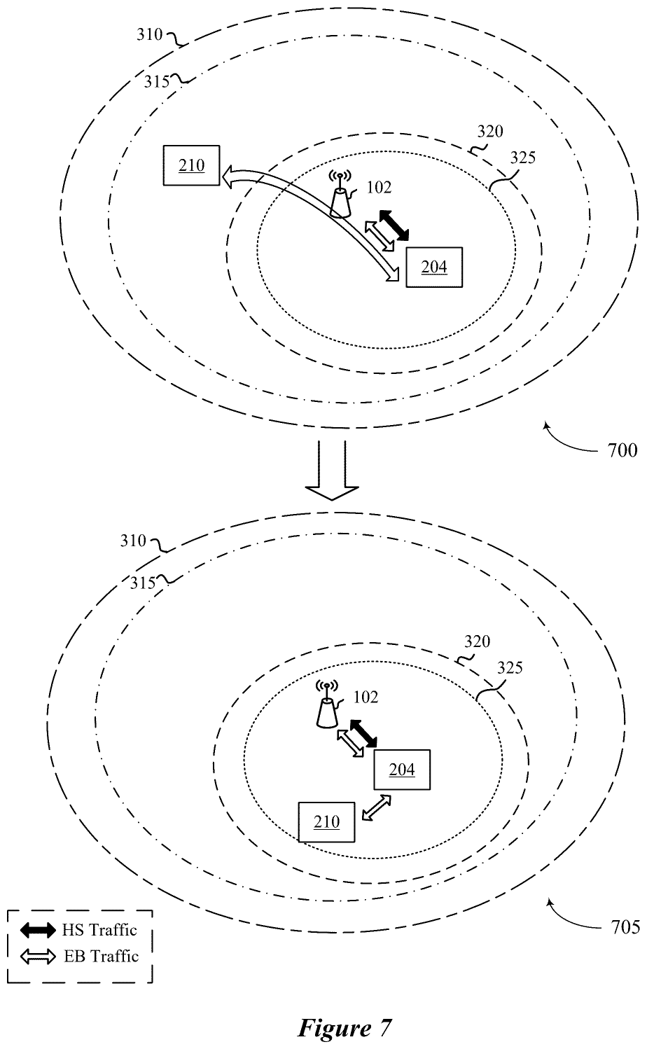

FIG. 7 illustrates an example in an XPAN scenario of a transition between a personal audio device-AP connection at a first time 700 and a P2P wireless connection at a second time 705. The example XPAN scenario illustrated in FIG. 7 includes the AP 102, the personal wireless communication device 204, and the personal audio device 210 described with reference to FIG. 3. For example, FIG. 7 may illustrate a scenario in which a user of XPAN enabled earbuds (personal audio device 210) moves back within the range of the personal wireless communication device 204. For example, a user of XPAN enabled earbuds may return to their desk on which they left their phone (personal wireless communication device 204).

At the first time 700, which may correspond to the second time 305 of FIG. 3, the personal audio device 210 is outside of the range of the personal wireless communication device 204 (both the 2.4G range 320 and the 5G/6G range 325), and the personal audio device 210 and the personal wireless communication device 204 may communicate audio data via the AP 102. Between the first time 700 and the second time 705, a user of the personal audio device 210 moves into the 5G/6G range of the personal wireless communication device 204.

As a direct P2P wireless communication link between the personal audio device 210 and the personal wireless communication device 204 has a lower latency than communications via the AP 102, at the second time 405, when the personal audio device 210 is within the 5G/6G range of the personal wireless communication device 204, the personal wireless communication device 204 and the personal audio device 210 may communicate audio data (shown as EB traffic) via the direct P2P wireless communication link. Accordingly, between the first time 700 and the second time 705, the personal audio device 210 may transition from a personal audio device-AP connection scenario to a personal audio device-personal wireless communication device connection scenario.

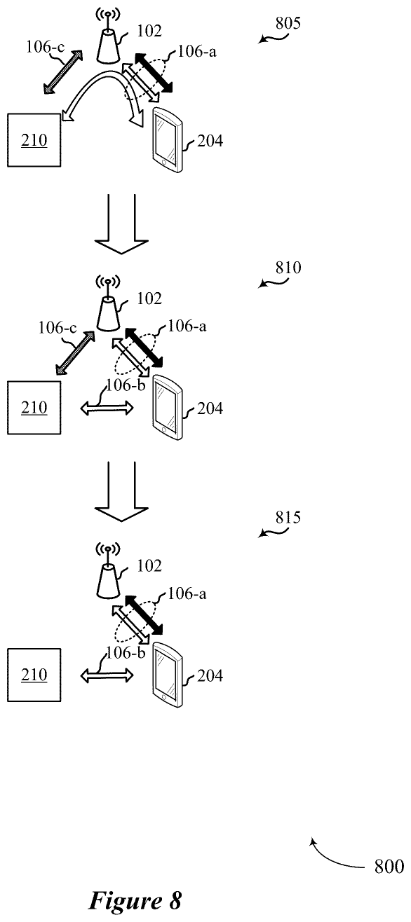

FIG. 8 illustrates an example of a transition in an XPAN scenario 800 between a personal audio device-AP connection and a P2P wireless connection. The XPAN scenario 805 includes the AP 102, the personal wireless communication device 204, and the personal audio device 210 described with reference to FIG. 4. As the transition illustrated in the XPAN scenario 800 exchanges data over BLE during establishment of the P2P connection between the personal audio device 210 and the personal wireless communication device 204, the transition may reduce latency and packet loss as compared to a transition from an AP connection to a P2P connection in which the connection to the P2P is not established prior to breaking the AP connection and/or in which data is not exchanged during the transition.

When the personal audio device 210 is connected to an AP 102 and the link quality degrades as the user is moving away from the serving AP 102 two potential scenarios may arise. In a first scenario, the personal audio device 210 may move into the coverage of another AP 102 within the same network of the current AP 102/personal wireless communication device 204. For example, the other AP 102 may be another mesh node or a range extender in a home mesh network, or another BSS in the same ESS. In the second scenario, the user may be moving back into the coverage of the personal wireless communication device 204. One solution may be that when the personal audio device 210 moves back into the coverage of the personal wireless communication device 204, and both are in a reasonable range of the serving AP 102, the personal audio device 210 may stay connected to the serving AP 102, though doing so may result in higher power consumption as compared to connecting directly to the personal wireless communication device 204. The second solution may be to switch back to the direct P2P wireless communication link with the personal wireless communication device 204.

In some examples, once the personal audio device 210 is outside of the direct coverage of the personal wireless communication device 204, the personal wireless communication device 204 may terminate the SAP link that was used for the XPAN P2P wireless communication link with the personal audio device 210, and the personal wireless communication device 204 may stop beaconing on that channel. In some examples, the personal audio device 210 may start the connection to the AP 102 directly outside the range of the personal wireless communication device 204 (such as by initiating a call through a voice assistance command from a distance).

To obtain RSSI at the personal audio device 210 from the personal wireless communication device 204, in some examples, if a previous P2P wireless communication link 106-b with the personal wireless communication device 204 was established, the personal wireless communication device 204 may maintain the SAP link for DTIM beaconing on the same channel for the duration of the XPAN session for the personal audio device 210. The personal wireless communication device 204 may reduce the periodicity of DTIM beaconing to save power/concurrency time. In some examples, if the link quality of the P2P wireless communication link 106-b exceeds a link quality threshold (such as based on the DTIM beaconing), the personal audio device 210 may switch to the channel on which the personal wireless communication device 204 is transmitting the DTIM beacons (the prior SAP channel). In some examples, if the link quality of the wireless communication link 106-c with the AP 102 falls below a link quality threshold, the personal audio device 210 may switch to the channel on which the personal wireless communication device 204 is transmitting the DTIM beacons (the prior SAP channel), if the link quality of the P2P wireless communication link 106-b exceeds a link quality threshold (such as based on the DTIM beaconing).

In some examples, to obtain RSSI at the personal audio device 210 from the personal wireless communication device 204, the personal audio device 210 may transmit an indication to the personal wireless communication device 204 via the AP 102 that the link quality of the wireless communication link 106-c with the AP 102 has fallen below a threshold and that the personal audio device 210 is evaluating a direct connection to the personal wireless communication device 204. In some examples, the indication may be sent using an uplink Vendor-Specific Action Frame to the personal wireless communication device 204 through the AP 102, TCP control link, or in a Real-time Transport Protocol (RTP) header. The personal wireless communication device 204 may communicate, with the personal audio device 210 over Wi-Fi through the AP 102, scheduling information for beacons, such as a specific channel on which the personal wireless communication device 204 is intending to transmit beacons (if the SAP link was terminated) and a time/periodicity of when the beacons will be transmitted, and/or a TBTT of the next beacon. The personal audio device 210 may listen to (such as monitor) the beacons on the indicated channel to measure the current RSSI of the P2P wireless communication link 106-b. Alternatively, the personal wireless communication device 204 may indicate to the personal audio device 210 a specific channel and a listen schedule, and the personal audio device 210 may transmit a probe request on that channel. In response to the probe request, the personal wireless communication device 204 may transmit a probe response to the personal audio device 210.

In some examples, to obtain RSSI at the personal audio device 210 from the personal wireless communication device 204, the personal audio device 210 may check if the personal audio device 210 is in BT coverage of the personal wireless communication device 204, and if so, the personal audio device 210 may send a proprietary indication over BT to indicate the intent of the personal audio device 210 to roam back to the P2P wireless communication link 106-b. The personal wireless communication device 204 may communicate over BT to the personal audio device 210 an indication of a specific channel on which the personal wireless communication device 204 is intending to send beacons (if the SAP link was terminated) and a time/periodicity of when the beacons will be sent. The personal audio device 210 may listen to the beacons on the indicated channel to measure the current RSSI of the P2P wireless communication link 106-b.

As shown in FIG. 8, at 805, the personal audio device 210 may communicate with the personal wireless communication device 204 via the AP 102 (via the wireless communication link 106-c between the personal audio device 210 and the AP 102 and the wireless communication link 106-a between the AP 102 and the personal wireless communication device 204). The personal audio device 210 may monitor the link quality of the wireless communication link 106-c. If the link quality of the wireless communication link 106-c drops below a first threshold (LQ_{AssocAP}) the personal audio device 210 may transmit a roaming indication to the personal wireless communication device 204 through Wi-Fi via the AP 102 or through BT if in BT range of the personal wireless communication device 204. The personal audio device 210 may measure RSSI of a beacon or probe response from the personal wireless communication device 204 on an SAP channel. The personal audio device 210 may calculate a utility function for the direct P2P wireless connection based on the RSSI of the beacon or probe response versus the wireless communication link 106-c.

At 810, if roaming to the P2P wireless connection provides a better utility function, the personal audio device 210 may perform an association/authentication procedure with the personal wireless communication device 204 to establish the P2P wireless communication link 106-b. At 810, the personal audio device 210 may be connected to both the personal wireless communication device 204 via the P2P wireless communication link 106-b and the AP 102 via the wireless communication link 106-c. Additionally, the personal audio device 210 may transition from the AP connection to the P2P connection via BLE. For example, the personal audio device 210 may switch data to be received via a Bluetooth wireless communication link and perform the association/authentication procedure with the personal wireless communication device 204 to establish the P2P wireless communication link 106-b while receiving the data over a Bluetooth wireless communication link. If the link quality of the wireless communication link 106-c falls below a second threshold (LQ_{roamHS}), the personal audio device 210 may deauthenticate/disassociate with the AP 102. Accordingly, at 815, the personal audio device 210 has a single connection, the P2P wireless communication link 106-b, and the personal wireless communication device 204 transfers data on the SAP link (the P2P wireless communication link 106-b) directly to the personal audio device 210.

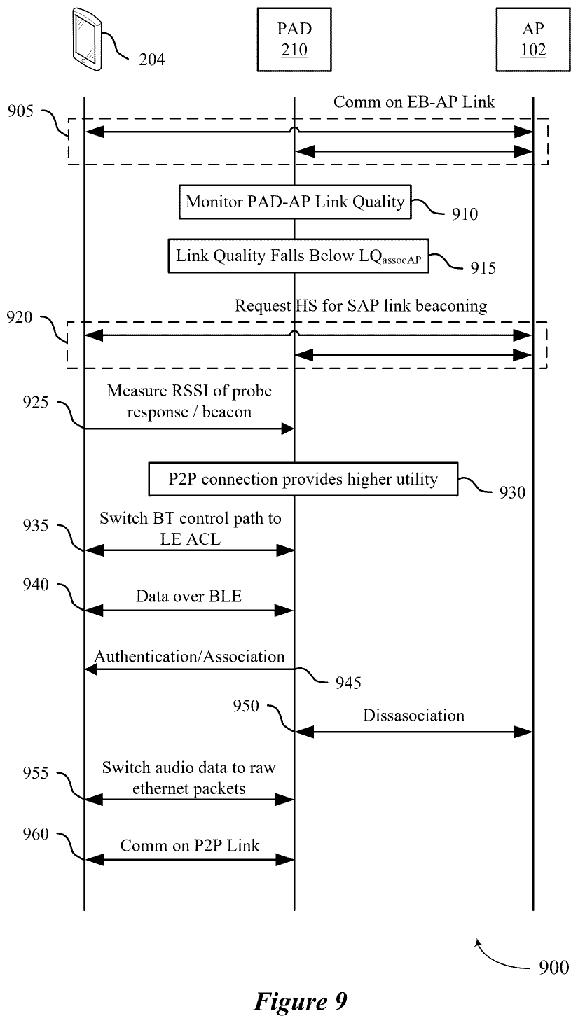

FIG. 9 illustrates an example of a process flow 900 of a transition in an XPAN scenario between a personal audio device-AP connection and a P2P wireless connection. The process flow 900 includes the AP 102, the personal wireless communication device 204, and the personal audio device 210 described with reference to FIG. 3. In the following description of the process flow 900, the operations between the AP 102, the personal wireless communication device 204, and the personal audio device 210 may be transmitted in a different order than the example order shown, or the operations performed by the AP 102, the personal wireless communication device 204, and the personal audio device 210 may be performed in different orders or at different times. Some operations also may be omitted from the process flow 900, and other operations may be added to the process flow 900. As the transition illustrated in the process flow 900 exchanges data over BLE during establishment of the P2P connection between the personal audio device 210 and the personal wireless communication device 204, the transition illustrated in the process flow 900 may reduce latency and packet loss as compared to a transition from an AP connection to a P2P connection in which the P2P connection is not established prior to breaking the AP connection and/or in which data is not exchanged during the transition. The transition illustrated in the process flow 900 may be associated with a transition during streaming.

At 905, the personal wireless communication device 204 and the personal audio device 210 may communicate via the AP 102 (via the wireless communication link 106-a and the wireless communication link 106-c of FIG. 8). For example, the personal wireless communication device 204 may encapsulate audio data in UDP packets. At 910, the personal audio device 210 may monitor the link quality of the wireless communication link between the personal audio device 210 and the AP 102 (the wireless communication link 106-c of FIG. 8). At 915, the personal audio device 210 may determine that the link quality of the wireless communication link between the personal audio device 210 and the AP 102 link drops below a first threshold (LQ_{assocAP}).

In response to the link quality of the wireless communication link between the personal audio device 210 and the AP 102 link dropping below the first threshold (LQ_{assocAP}), at 920, if the personal wireless communication device 204 stopped beacons over the SAP link, the personal audio device 210 transmits a request to the personal wireless communication device 204 (via Wi-Fi through the AP 102 or via BT) for beaconing or transmits a probe request. At 925, the personal audio device 210 measures the RSSI of the beacon or probe response transmitted by the personal wireless communication device 204 on the SAP link. At 930, the personal audio device 210 determines that the direct P2P connection to the personal wireless communication device 204 provides a higher utility than the connection through the AP 102 via the wireless communication link between the personal audio device 210 and the AP 102. In scenarios where there are two personal audio devices (such as two XPAN-capable earbuds), the primary personal audio device 210 may share the determination that the direct P2P connection to the personal wireless communication device 204 provides a higher utility than the connection through the AP 102 via the wireless communication link between the personal audio device 210 and the AP 102. Additionally, or alternatively, the personal audio device 210 may transmit a roaming request to the AP 102, which may, based on receiving the roaming request, indicate the roaming request to the personal wireless communication device 204.

At 935, in response to the determination at 930, the personal wireless communication device 204 switches the BT control path to LE ACL. At 940, the personal audio device 210 may communicate data over a BLE link with the personal wireless communication device 204. In some examples, the personal audio device 210 may receive data via the BLE link and via the connection with the AP 102. At 945, the personal audio device 210 performs an association procedure with the personal wireless communication device 204. At 950, the personal audio device 210 may disassociate from/deauthenticate with AP 102.

At 955, the personal wireless communication device 204 may switch audio data to raw ethernet packets. At 960, the personal audio device 210 may communicate with the personal wireless communication device 204 via the P2P wireless communication link (such as the P2P wireless communication link 106-b of FIG. 8).

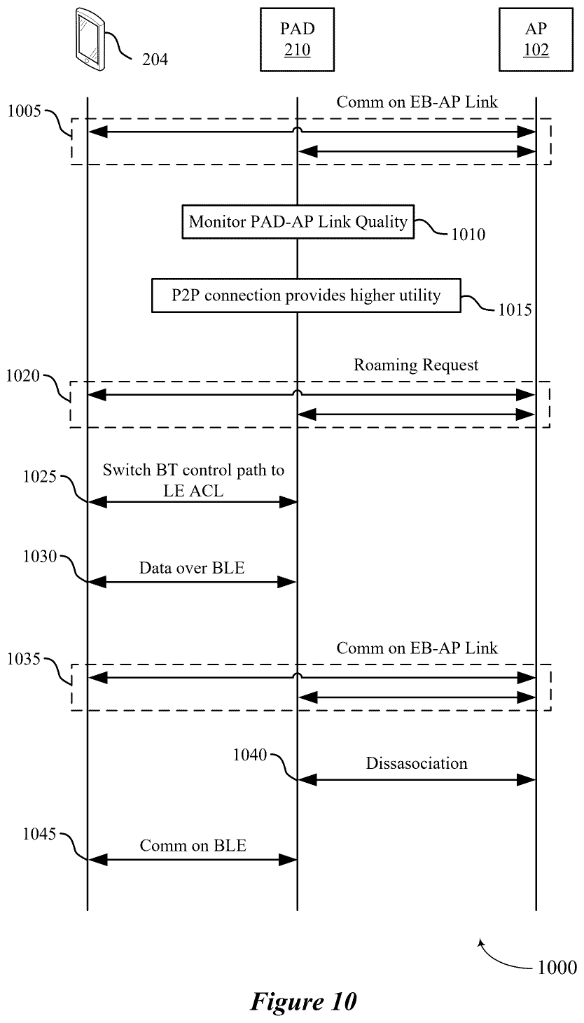

FIG. 10 illustrates an example of a process flow 1000 of a transition in an XPAN scenario between a personal audio device-AP connection and a P2P wireless connection. The process flow 1000 includes the AP 102, the personal wireless communication device 204, and the personal audio device 210 described with reference to FIG. 3. In the following description of the process flow 1000, the operations between the AP 102, the personal wireless communication device 204, and the personal audio device 210 may be transmitted in a different order than the example order shown, or the operations performed by the AP 102, the personal wireless communication device 204, and the personal audio device 210 may be performed in different orders or at different times. Some operations also may be omitted from the process flow 1000, and other operations may be added to the process flow 1000. As the transition illustrated in the process flow 1000 exchanges data over BLE during establishment of the P2P connection between the personal audio device 210 and the personal wireless communication device 204, the transition illustrated in the process flow 1000 may reduce latency and packet loss as compared to a transition from an AP connection to a P2P connection in which the P2P connection is not established prior to breaking the AP connection and/or in which data is not exchanged during the transition. The transition illustrated in the process flow 1000 may be associated with a transition during a voice call.

At 1005, the personal wireless communication device 204 and the personal audio device 210 may communicate via the AP 102 (via the wireless communication link 106-a and the wireless communication link 106-c of FIG. 8). For example, the personal wireless communication device 204 may encapsulate audio data in UDP packets. At 1010, the personal audio device 210 may monitor the link quality of the wireless communication link between the personal audio device 210 and the AP 102 (the wireless communication link 106-c of FIG. 8). At 1015, the personal audio device 210 determines that the HS BLE connection to the personal wireless communication device 204 provides a higher utility than the connection through the AP 102 via the wireless communication link between the personal audio device 210 and the AP 102. In scenarios where there are two personal audio devices (such as two XPAN-capable earbuds), the primary personal audio device 210 may share the determination that the HS BLE connection to the personal wireless communication device 204 provides a higher utility than the connection through the AP 102 via the wireless communication link between the personal audio device 210 and the AP 102. Additionally, or alternatively, the personal audio device 210 may transmit a roaming request to the AP 102, which may, based on receiving the roaming request, indicate the roaming request to the personal wireless communication device 204.

In response to the determination that the HS BLE connection provides the higher utility, at 1020, the personal audio device 210 may transmit a roaming request to the AP 102, which may, based on receiving the roaming request, indicate the roaming request to the personal wireless communication device 204.

At 1025, in response to the determination at 1015, the personal wireless communication device 204 switches the BT control path to LE ACL. At 1030, the personal audio device 210 may communicate data over a BLE link with the personal wireless communication device 204. In some examples, the personal audio device 210 may receive data via the BLE link and via the connection with the AP 102. At 1035, the personal audio device 210 may receive data from the personal wireless communication device 204 via the AP 102, such as via the EB-AP link. At 1040, the personal audio device 210 may disassociate from/deauthenticate with AP 102.

At 1045, the personal wireless communication device 204 may communicate with the personal audio device 210 via the BLE link.

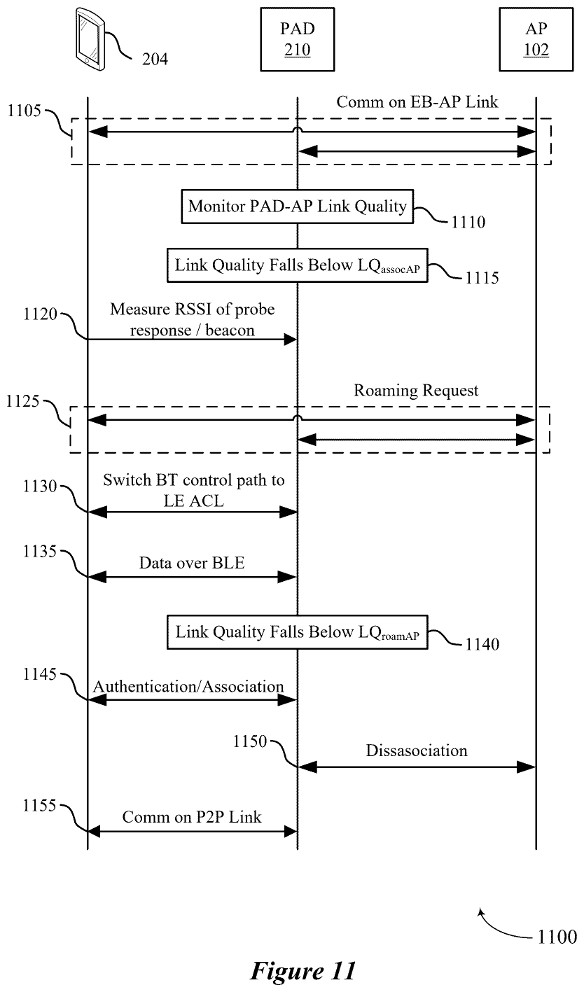

FIG. 11 illustrates an example of a process flow 1100 of a transition in an XPAN scenario between a personal audio device-AP connection and a P2P wireless connection. The process flow 1100 includes the AP 102, the personal wireless communication device 204, and the personal audio device 210 described with reference to FIG. 3. In the following description of the process flow 1100, the operations between the AP 102, the personal wireless communication device 204, and the personal audio device 210 may be transmitted in a different order than the example order shown, or the operations performed by the AP 102, the personal wireless communication device 204, and the personal audio device 210 may be performed in different orders or at different times. Some operations also may be omitted from the process flow 1100, and other operations may be added to the process flow 1000. As the transition illustrated in the process flow 1100 exchanges data over BLE during establishment of the P2P connection between the personal audio device 210 and the personal wireless communication device 204, the transition illustrated in the process flow 1100 may reduce latency and packet loss as compared to a transition from an AP connection to a P2P connection in which the P2P connection is not established prior to breaking the AP connection and/or in which data is not exchanged during the transition.

At 1105, the personal wireless communication device 204 and the personal audio device 210 may communicate via the AP 102 (via the wireless communication link 106-a and the wireless communication link 106-c of FIG. 8). For example, the personal wireless communication device 204 may encapsulate audio data in UDP packets. At 1110, the personal audio device 210 may monitor the link quality of the wireless communication link between the personal audio device 210 and the AP 102 (the wireless communication link 106-c of FIG. 8). At 1115, the personal audio device 210 may determine that the link quality of the wireless communication link between the personal audio device 210 and the AP 102 falls below the threshold LQ_{AssocAP}. In other words, the personal audio device 210 may determine an LE roaming trigger is activated. At 1120 and in response to the determination that the link quality of the P2P wireless communication link falls below the threshold LQ_{AssocAP}, the personal audio device 210 may measure the RSSI of a probe response or beacon from the personal wireless communication device 204. In scenarios where there are two personal audio devices (such as two XPAN-capable earbuds), the primary personal audio device 210 may share a decision regarding a link between the personal audio device 210 and the AP 102 with a secondary personal audio device. Additionally, or alternatively, at 1125 the personal audio device 210 may transmit a roaming request to the AP 102, which may, based on receiving the roaming request, indicate the roaming request to the personal wireless communication device 204.

The personal wireless communication device 204 may reduce an audio bit rate (such as in accordance with a BLE wireless communication link) and/or enable a LE link (such as establish CIS). In some examples, in response to enabling the LE link, at 1130, the personal wireless communication device 204 may transmit a LE ACL connect request to the personal audio device 210. In response to the LE ACL connect request, the personal audio device 210 may transmit an audio bearer switch request or response. In other words, in response to determining that the link quantity falls below the threshold LQ_{AssocAP}, the personal audio device 210 may switch an audio bearer to BLE.

At 1135, the personal audio device 210 may communicate data over a BLE link with the personal wireless communication device 204. In some examples, the personal audio device 210 may receive data via the BLE link and via the connection with the AP 102. At 1035, the personal audio device 210 may receive data from the personal wireless communication device 204 via the AP 102, such as via the EB-AP link.

At 1140, the personal audio device 210 may determine that the link quality of the wireless communication link between the personal audio device and the AP 102 drops below a second threshold (LQ_{roamAP}). In response to the determination at 1140, the personal audio device 210 may perform, at 1145, an authentication/association for the personal wireless communication device 204, and, at 1150, disassociate from/deauthenticate with AP 102.

At 1155, the personal wireless communication device 204 may communicate with the personal audio device 210 via the P2P wireless communication link.

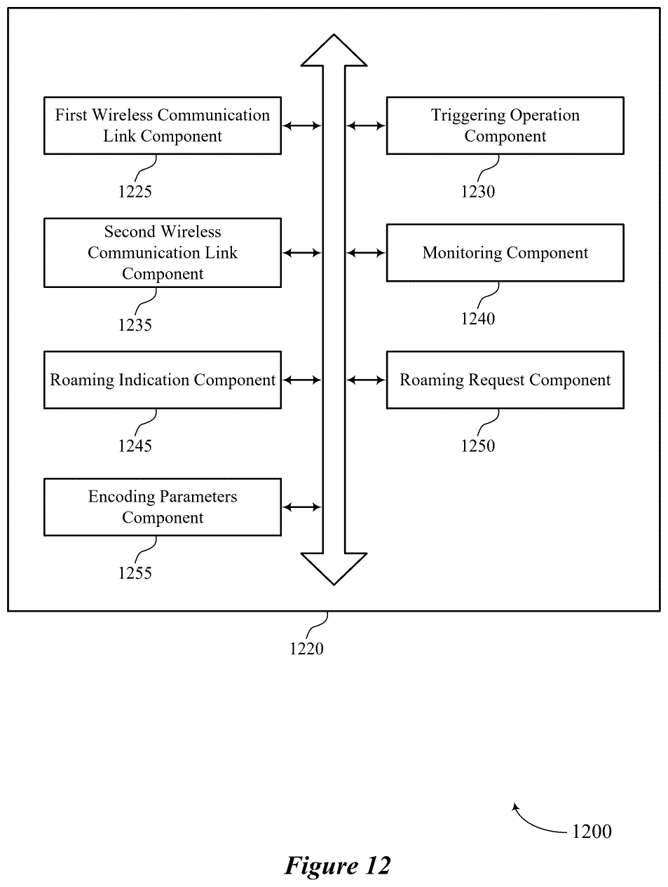

FIG. 12 shows a block diagram 1200 of a wireless communication device 1220 that supports Bluetooth assisted Wi-Fi operations for personal area network devices. The wireless communication device 1220 may be an example of aspects of a Bluetooth Device as described with reference to FIGS. 1 through 11. The wireless communication device 1220, or various components thereof, may be an example of means for performing various aspects of Bluetooth assisted Wi-Fi operations for personal area network devices as described herein. For example, the wireless communication device 1220 may include a first wireless communication link component 1225, a triggering operation component 1230, a second wireless communication link component 1235, a monitoring component 1240, a roaming indication component 1245, a roaming request component 1250, an encoding parameters component 1255, or any combination thereof. Each of these components, or components or subcomponents thereof (such as one or more processors, one or more memories), may communicate, directly or indirectly, with one another (such as via one or more buses).

The wireless communication device 1220 (such as a first wireless communication device or a personal audio device) may support wireless communication in accordance with examples as disclosed herein. The first wireless communication link component 1225 is configurable or configured to communicate, with a second wireless communication device via a first wireless communication link associated with a first wireless protocol, a first set of audio data associated with an application for the first wireless communication device. The triggering operation component 1230 is configurable or configured to receive, from the second wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol. The second wireless communication link component 1235 is configurable or configured to communicate, with the second wireless communication device via the second wireless communication link during the triggering operation, a second set of audio data associated with the application in response to the request to switch.

In some examples, the triggering operation includes a roaming operation, and the monitoring component 1240 is configurable or configured to monitor one or more channels associated with the first wireless communication link. In some examples, the triggering operation includes a roaming operation, and the roaming indication component 1245 is configurable or configured to transmit, via the first wireless communication link, a roaming indication in response to a channel quality of the one or more channels associated with the first wireless communication link falling below a threshold channel quality, where the request to switch audio communications is received in response to the roaming indication.

In some examples, the roaming indication component 1245 is configurable or configured to receive, from a third wireless communication device (such as an AP) and in accordance with the roaming indication, an indication of an IP address for the first wireless communication device while communicating the second set of audio data with the second wireless communication device via the second wireless communication link.

In some examples, the roaming indication component 1245 is configurable or configured to transmit the IP address to the second wireless communication device in response to the indication of the IP address while communicating the second set of audio data with the second wireless communication device via the second wireless communication link.

In some examples, the triggering operation includes a roaming operation, and the monitoring component 1240 is configurable or configured to monitor one or more channels associated with the first wireless communication link. In some examples, the triggering operation includes a roaming operation, and the roaming indication component 1245 is configurable or configured to transmit, via the first wireless communication link, a roaming indication in response to a congestion level of the one or more channels associated with the first wireless communication link exceeding a threshold congestion level, where the request to switch audio communications is received in response to the roaming indication.

In some examples, the triggering operation includes a roaming operation, and the roaming request component 1250 is configurable or configured to transmit a roaming request message including audio destination information, the audio destination information indicating the second wireless protocol for audio communications associated with the application.

In some examples, the first wireless communication link includes a peer to peer communication link and the second wireless communication link includes a WLAN communication link, and the first wireless communication link component 1225 is configurable or configured to communicate, while communicating the second set of audio data with the second wireless communication device via the second wireless communication link, a third set of audio data associated with the application via the first wireless communication link.

In some examples, the triggering operation component 1230 is configurable or configured to perform the triggering operation while communicating the second set of audio data with the second wireless communication device via the second wireless communication link, where the triggering operation includes a channel scanning operation, a channel switching operation, a roaming operation, or any combination thereof.

In some examples, to support communicating the first set of audio data, the encoding parameters component 1255 is configurable or configured to communicate the first set of audio data according to a first set of encoding parameters.

In some examples, to support communicating the second set of audio data, the encoding parameters component 1255 is configurable or configured to communicate the second set of audio data according to a second set of encoding parameters different from the first set of encoding parameters and corresponding to a reduced bit rate or increased latency relative to the first set of encoding parameters.

In some examples, the first wireless protocol includes one of WLAN protocol or BLUETOOTH protocol. In some examples, the second wireless protocol includes one of the BLUETOOTH protocol or the WLAN protocol.

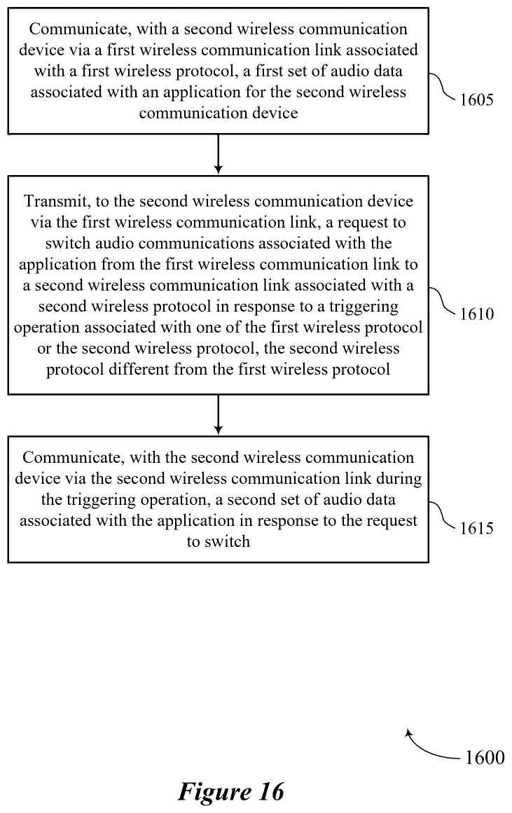

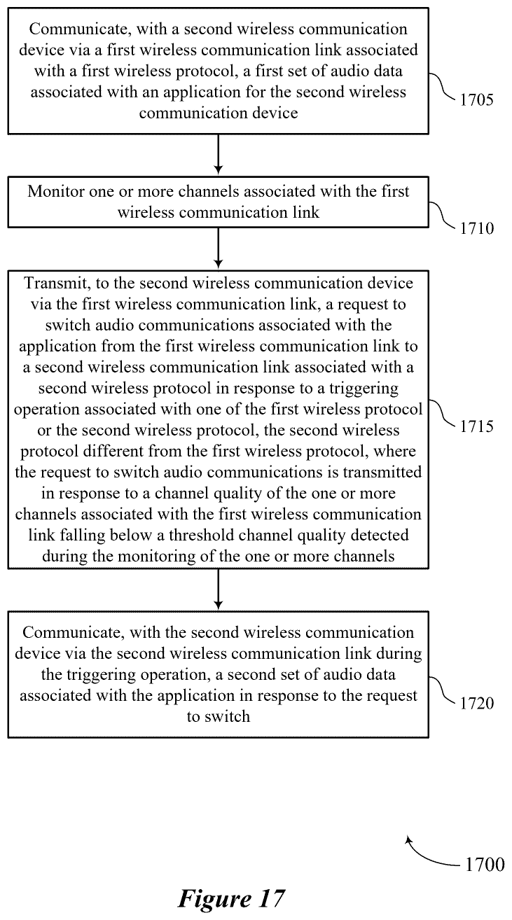

FIG. 13 shows a block diagram of an example wireless communication device 1300 that supports Bluetooth assisted Wi-Fi operations for personal area network devices. In some examples, the wireless communication device 1300 is configured to perform the processes 1600 and 1700 described with reference to FIGS. 16 and 17, respectively. The wireless communication device 1300 may include one or more chips, SoCs, chipsets, packages, components or devices that individually or collectively constitute or include a processing system. The processing system may interface with other components of the wireless communication device 1300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1300 may transmit the information output from the chip. In such an example, the second interface may refer to an interface between the processing system of the chip and a reception component, such that the wireless communication device 1300 may receive information that is then passed to the processing system. In some such examples, the first interface also may obtain information, such as from the transmission component, and the second interface also may output information, such as to the reception component.

The processing system of the wireless communication device 1300 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the multiple processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1300 (such as a second wireless communication device) can be configurable or configured for use in a STA, such as the STA 104 described with reference to FIG. 1. In some other examples, the wireless communication device 1300 can be a STA that includes such a processing system and other components including multiple antennas. The wireless communication device 1300 is capable of transmitting and receiving wireless communications in the form of, for example, wireless packets. For example, the wireless communication device 1300 can be configurable or configured to transmit and receive packets in the form of physical layer PPDUs and MPDUs conforming to one or more of the IEEE 802.11 family of wireless communication protocol standards. In some other examples, the wireless communication device 1300 can be configurable or configured to transmit and receive signals and communications conforming to one or more 3GPP specifications including those for 5G NR or 6G. In some examples, the wireless communication device 1300 also includes or can be coupled with one or more application processors which may be further coupled with one or more other memories. In some examples, the wireless communication device 1300 further includes a user interface (UI) (such as a touchscreen or keypad) and a display, which may be integrated with the UI to form a touchscreen display that is coupled with the processing system. In some examples, the wireless communication device 1300 may further include one or more sensors such as, for example, one or more inertial sensors, accelerometers, temperature sensors, pressure sensors, or altitude sensors, that are coupled with the processing system.

The wireless communication device 1300 includes a first wireless communication link component 1325, a triggering operation component 1330, a second wireless communication link component 1335, a monitoring component 1340, a roaming request component 1345, and an encoding parameters component 1350. Portions of one or more of the first wireless communication link component 1325, the triggering operation component 1330, the second wireless communication link component 1335, the monitoring component 1340, the roaming request component 1345, and the encoding parameters component 1350 may be implemented at least in part in hardware or firmware. For example, one or more of the first wireless communication link component 1325, the triggering operation component 1330, the second wireless communication link component 1335, the monitoring component 1340, the roaming request component 1345, and the encoding parameters component 1350 may be implemented at least in part by at least a processor or a modem. In some examples, portions of one or more of the first wireless communication link component 1325, the triggering operation component 1330, the second wireless communication link component 1335, the monitoring component 1340, the roaming request component 1345, and the encoding parameters component 1350 may be implemented at least in part by a processor and software in the form of processor-executable code stored in memory.

The wireless communication device 1300 may support wireless communication in accordance with examples as disclosed herein. The first wireless communication link component 1325 is configurable or configured to communicate, with a first wireless communication device via a first wireless communication link associated with a first wireless protocol, a first set of audio data associated with an application for the first wireless communication device. The triggering operation component 1330 is configurable or configured to transmit, to the first wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol. The second wireless communication link component 1335 is configurable or configured to communicate, with the first wireless communication device via the second wireless communication link during the triggering operation, a second set of audio data associated with the application in response to the request to switch.

In some examples, the monitoring component 1340 is configurable or configured to monitor one or more channels associated with the first wireless communication link, where the request to switch audio communications is transmitted in response to a channel quality of the one or more channels associated with the first wireless communication link falling below a threshold channel quality detected during the monitoring of the one or more channels.

In some examples, the monitoring component 1340 is configurable or configured to monitor one or more channels associated with the first wireless communication link, where the request to switch audio communications is transmitted in response to a congestion level of the one or more channels associated with the first wireless communication link falling below a threshold congestion level detected during the monitoring of the one or more channels.

In some examples, the triggering operation includes a roaming operation, and the roaming request component 1345 is configurable or configured to receive, from the first wireless communication device, a roaming request message including audio destination information, the audio destination information indicating the second wireless protocol for audio communications associated with the application.

In some examples, the roaming request component 1345 is configurable or configured to receive, from the first wireless communication device, an IP address of the first wireless communication device while communicating the second set of audio data with the first wireless communication device via the second wireless communication link.

In some examples, the triggering operation component 1330 is configurable or configured to perform the triggering operation while communicating the second set of audio data with the wireless communication device via the second wireless communication link, where the triggering operation includes a channel scanning operation, a channel switching operation, a roaming operation, or any combination thereof.

In some examples, the first wireless communication link includes a peer to peer communication link and the second wireless communication link includes a WLAN communication link, and the first wireless communication link component 1325 is configurable or configured to communicate, while communicating the second set of audio data with the first wireless communication device via the second wireless communication link, a third set of audio data associated with the application via the first wireless communication link.

In some examples, to support communicating the first set of audio data, the encoding parameters component 1350 is configurable or configured to communicate the first set of audio data according to a first set of encoding parameters.

In some examples, the encoding parameters component 1350 is configurable or configured to communicate the second set of audio data according to a second set of encoding parameters different from the first set of encoding parameters and corresponding to a reduced bit rate relative to the first set of encoding parameters.

In some examples, the first wireless protocol includes one of WLAN protocol or BLUETOOTH protocol. In some examples, the second wireless protocol includes one of the BLUETOOTH protocol or the WLAN protocol.

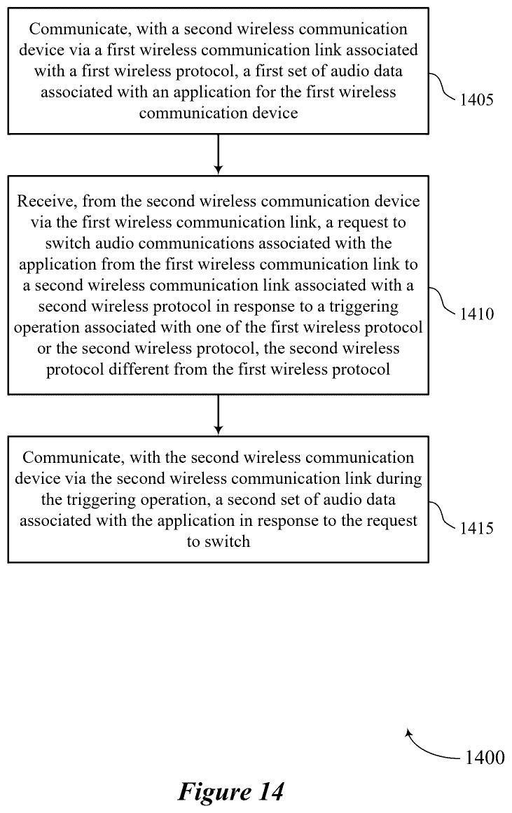

FIG. 14 shows a flowchart illustrating a method 1400 that supports Bluetooth assisted Wi-Fi operations for personal area network devices. The operations of the method 1400 may be implemented by a Bluetooth Device or its components as described herein. For example, the operations of the method 1400 may be performed by a Bluetooth Device as described with reference to FIGS. 1 through 12. In some examples, a Bluetooth Device may execute a set of instructions to control the functional elements of the Bluetooth Device to perform the described functions. Additionally, or alternatively, the Bluetooth Device may perform aspects of the described functions using special-purpose hardware.

At 1405, the method may include communicating, with a second wireless communication device via a first wireless communication link associated with a first wireless protocol, a first set of audio data associated with an application for the first wireless communication device. The operations of 1405 may be performed in accordance with examples as disclosed herein. In some examples, aspects of the operations of 1405 may be performed by a first wireless communication link component 1225 as described with reference to FIG. 12.

At 1410, the method may include receiving, from the second wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol. The operations of 1410 may be performed in accordance with examples as disclosed herein. In some examples, aspects of the operations of 1410 may be performed by a triggering operation component 1230 as described with reference to FIG. 12.

At 1415, the method may include communicating, with the second wireless communication device via the second wireless communication link during the triggering operation, a second set of audio data associated with the application in response to the request to switch. The operations of 1415 may be performed in accordance with examples as disclosed herein. In some examples, aspects of the operations of 1415 may be performed by a second wireless communication link component 1235 as described with reference to FIG. 12.

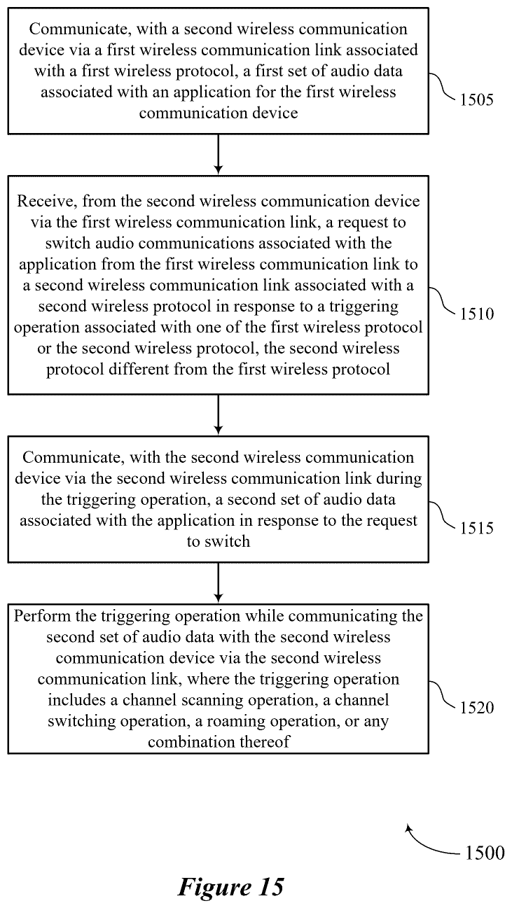

FIG. 15 shows a flowchart illustrating a method 1500 that supports Bluetooth assisted Wi-Fi operations for personal area network devices. The operations of the method 1500 may be implemented by a Bluetooth Device or its components as described herein. For example, the operations of the method 1500 may be performed by a Bluetooth Device as described with reference to FIGS. 1 through 12. In some examples, a Bluetooth Device may execute a set of instructions to control the functional elements of the Bluetooth Device to perform the described functions. Additionally, or alternatively, the Bluetooth Device may perform aspects of the described functions using special-purpose hardware.

At 1505, the method may include communicating, with a second wireless communication device via a first wireless communication link associated with a first wireless protocol, a first set of audio data associated with an application for the first wireless communication device. The operations of 1505 may be performed in accordance with examples as disclosed herein. In some examples, aspects of the operations of 1505 may be performed by a first wireless communication link component 1225 as described with reference to FIG. 12.

At 1510, the method may include receiving, from the second wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol. The operations of 1510 may be performed in accordance with examples as disclosed herein. In some examples, aspects of the operations of 1510 may be performed by a triggering operation component 1230 as described with reference to FIG. 12.

At 1515, the method may include communicating, with the second wireless communication device via the second wireless communication link during the triggering operation, a second set of audio data associated with the application in response to the request to switch. The operations of 1515 may be performed in accordance with examples as disclosed herein. In some examples, aspects of the operations of 1515 may be performed by a second wireless communication link component 1235 as described with reference to FIG. 12.

At 1520, the method may include performing the triggering operation while communicating the second set of audio data with the second wireless communication device via the second wireless communication link, where the triggering operation includes a channel scanning operation, a channel switching operation, a roaming operation, or any combination thereof. The operations of 1520 may be performed in accordance with examples as disclosed herein. In some examples, aspects of the operations of 1520 may be performed by a triggering operation component 1230 as described with reference to FIG. 12.

FIG. 16 shows a flowchart illustrating an example process 1600 performable by or at a second wireless communication device that supports Bluetooth assisted Wi-Fi operations for personal area network devices. The operations of the process 1600 may be implemented by a second wireless communication device or its components as described herein. For example, the process 1600 may be performed by a wireless communication device, such as the wireless communication device 1300 described with reference to FIG. 13, operating as or within a wireless STA. In some examples, the process 1600 may be performed by a wireless STA, such as one of the STAs 104 described with reference to FIG. 1.

In some examples, in 1605, the second wireless communication device may communicate, with a first wireless communication device via a first wireless communication link associated with a first wireless protocol, a first set of audio data associated with an application for the first wireless communication device. The operations of 1605 may be performed in accordance with examples as disclosed herein. In some implementations, aspects of the operations of 1605 may be performed by a first wireless communication link component 1325 as described with reference to FIG. 13.

In some examples, in 1610, the second wireless communication device may transmit, to the first wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol. The operations of 1610 may be performed in accordance with examples as disclosed herein. In some implementations, aspects of the operations of 1610 may be performed by a triggering operation component 1330 as described with reference to FIG. 13.

In some examples, in 1615, the second wireless communication device may communicate, with the first wireless communication device via the second wireless communication link during the triggering operation, a second set of audio data associated with the application in response to the request to switch. The operations of 1615 may be performed in accordance with examples as disclosed herein. In some implementations, aspects of the operations of 1615 may be performed by a second wireless communication link component 1335 as described with reference to FIG. 13.

FIG. 17 shows a flowchart illustrating an example process 1700 performable by or at a second wireless communication device that supports Bluetooth assisted Wi-Fi operations for personal area network devices. The operations of the process 1700 may be implemented by a second wireless communication device or its components as described herein. For example, the process 1700 may be performed by a wireless communication device, such as the wireless communication device 1300 described with reference to FIG. 13, operating as or within a wireless STA. In some examples, the process 1700 may be performed by a wireless STA, such as one of the STAs 104 described with reference to FIG. 1.

In some examples, in 1705, the second wireless communication device may communicate, with a first wireless communication device via a first wireless communication link associated with a first wireless protocol, a first set of audio data associated with an application for the first wireless communication device. The operations of 1705 may be performed in accordance with examples as disclosed herein. In some implementations, aspects of the operations of 1705 may be performed by a first wireless communication link component 1325 as described with reference to FIG. 13.

In some examples, in 1710, the second wireless communication device may monitor one or more channels associated with the first wireless communication link. The operations of 1710 may be performed in accordance with examples as disclosed herein. In some implementations, aspects of the operations of 1710 may be performed by a monitoring component 1340 as described with reference to FIG. 13.

In some examples, in 1715, the second wireless communication device may transmit, to the first wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol, where the request to switch audio communications is transmitted in response to a channel quality of the one or more channels associated with the first wireless communication link falling below a threshold channel quality detected during the monitoring of the one or more channels. The operations of 1715 may be performed in accordance with examples as disclosed herein. In some implementations, aspects of the operations of 1715 may be performed by a triggering operation component 1330 as described with reference to FIG. 13.

In some examples, in 1720, the second wireless communication device may communicate, with the first wireless communication device via the second wireless communication link during the triggering operation, a second set of audio data associated with the application in response to the request to switch. The operations of 1720 may be performed in accordance with examples as disclosed herein. In some implementations, aspects of the operations of 1720 may be performed by a second wireless communication link component 1335 as described with reference to FIG. 13.

Implementation examples are described in the following numbered clauses:

Clause 1: A method for wireless communication at a first wireless communication device, comprising: communicating, with a second wireless communication device via a first wireless communication link associated with a first wireless protocol, a first set of audio data associated with an application for the first wireless communication device; receiving, from the second wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol; and communicating, with the second wireless communication device via the second wireless communication link during the triggering operation, a second set of audio data associated with the application in response to the request to switch.

Clause 2: The method of clause 1, wherein the triggering operation comprises a roaming operation, the method further comprising: monitoring one or more channels associated with the first wireless communication link; and transmitting, via the first wireless communication link, a roaming indication in response to a channel quality of the one or more channels associated with the first wireless communication link falling below a threshold channel quality, wherein the request to switch audio communications is received in response to the roaming indication.

Clause 3: The method of clause 2, further comprising: receiving, from a third wireless communication device and in accordance with the roaming indication, an indication of an IP address for the first wireless communication device while communicating the second set of audio data with the second wireless communication device via the second wireless communication link.

Clause 4: The method of clause 3, further comprising: transmitting the IP address to the second wireless communication device in response to the indication of the IP address while communicating the second set of audio data with the second wireless communication device via the second wireless communication link.

Clause 5: The method of any of clauses 1 through 4, wherein the triggering operation comprises a roaming operation, the method further comprising: monitoring one or more channels associated with the first wireless communication link; and transmitting, via the first wireless communication link, a roaming indication in response to a congestion level of the one or more channels associated with the first wireless communication link exceeding a threshold congestion level, wherein the request to switch audio communications is received in response to the roaming indication.

Clause 6: The method of any of clauses 1 through 5, wherein the triggering operation comprises a roaming operation, the method further comprising: transmitting a roaming request message comprising audio destination information, the audio destination information indicating the second wireless protocol for audio communications associated with the application.

Clause 7: The method of any of clauses 1 through 6, wherein the first wireless communication link comprises a peer to peer communication link and the second wireless communication link comprises a WLAN communication link, the method further comprising: communicating, while communicating the second set of audio data with the second wireless communication device via the second wireless communication link, a third set of audio data associated with the application via the first wireless communication link.

Clause 8: The method of any of clauses 1 through 7, further comprising: performing the triggering operation while communicating the second set of audio data with the second wireless communication device via the second wireless communication link, wherein the triggering operation comprises a channel scanning operation, a channel switching operation, a roaming operation, or any combination thereof.

Clause 9: The method of any of clauses 1 through 8, wherein the first wireless communication link comprises a WLAN communication link and the second wireless communication link comprises a peer to peer communication link, wherein communicating the first set of audio data comprises: communicating the first set of audio data according to a first set of encoding parameters.

Clause 10: The method of clause 9, wherein communicating the second set of audio data comprises: communicating the second set of audio data according to a second set of encoding parameters different from the first set of encoding parameters and corresponding to a reduced bit rate or increased latency relative to the first set of encoding parameters.

Clause 11: The method of any of clauses 1 through 10, wherein the first wireless protocol comprises one of WLAN protocol or BLUETOOTH protocol; and the second wireless protocol comprises one of the BLUETOOTH protocol or the WLAN protocol.

Clause 12: A method for wireless communication at a second wireless communication device, comprising: communicating, with a first wireless communication device via a first wireless communication link associated with a first wireless protocol, a first set of audio data associated with an application for the first wireless communication device; transmitting, to the first wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol; and communicating, with the first wireless communication device via the second wireless communication link during the triggering operation, a second set of audio data associated with the application in response to the request to switch.

Clause 13: The method of clause 12, further comprising: monitoring one or more channels associated with the first wireless communication link, wherein the request to switch audio communications is transmitted in response to a channel quality of the one or more channels associated with the first wireless communication link falling below a threshold channel quality detected during the monitoring of the one or more channels.

Clause 14: The method of any of clauses 12 through 13, further comprising: monitoring one or more channels associated with the first wireless communication link, wherein the request to switch audio communications is transmitted in response to a congestion level of the one or more channels associated with the first wireless communication link falling below a threshold congestion level detected during the monitoring of the one or more channels.

Clause 15: The method of any of aspects 12 through 14, wherein the triggering operation comprises a roaming operation, further comprising: receive a roaming indication, wherein the request to switch audio communications is transmitted in response to the roaming indication.

Clause 16: The method of aspect 17, wherein the roaming indication is received from the first wireless communication device, from one or more components of the second wireless communication device, or both.

Clause 17: The method of any of clauses 12 through 14, wherein the triggering operation comprises a roaming operation, the method further comprising: receiving, from the first wireless communication device, a roaming request message comprising audio destination information, the audio destination information indicating the second wireless protocol for audio communications associated with the application.

Clause 18: The method of clause 17, further comprising: receiving, from the first wireless communication device, an IP address of the first wireless communication device while communicating the second set of audio data with the first wireless communication device via the second wireless communication link.

Clause 19: The method of any of clauses 12 through 18, further comprising: performing the triggering operation while communicating the second set of audio data with the first wireless communication device via the second wireless communication link, wherein the triggering operation comprises a channel scanning operation, a channel switching operation, a roaming operation, or any combination thereof.

Clause 20: The method of any of clauses 12 through 19, wherein the first wireless communication link comprises a peer to peer communication link and the second wireless communication link comprises a WLAN communication link, the method further comprising: communicating, while communicating the second set of audio data with the first wireless communication device via the second wireless communication link, a third set of audio data associated with the application via the first wireless communication link.

Clause 21: The method of any of clauses 12 through 20, wherein the first wireless communication link comprises a WLAN communication link and the second wireless communication link comprises a peer to peer communication link, wherein communicating the first set of audio data comprises: communicating the first set of audio data according to a first set of encoding parameters.

Clause 22: The method of clause 21, further comprising: communicating the second set of audio data according to a second set of encoding parameters different from the first set of encoding parameters and corresponding to a reduced bit rate relative to the first set of encoding parameters.

Clause 23: The method of any of clauses 12 through 22, wherein the first wireless protocol comprises one of wireless location area network (WLAN) protocol or BLUETOOTH protocol; and the second wireless protocol comprises one of the BLUETOOTH protocol or the WLAN protocol.

Clause 24: A first wireless communication device for wireless communication, comprising one or more memories storing processor-executable code, and one or more processors coupled with the one or more memories and individually or collectively operable to execute the code to cause the first wireless communication device to perform a method of any of clauses 1 through 11.

Clause 25: A first wireless communication device for wireless communication, comprising at least one means for performing a method of any of clauses 1 through 11.

Clause 26: A non-transitory computer-readable medium storing code for wireless communication, the code comprising instructions executable by one or more processors to perform a method of any of clauses 1 through 11.

Clause 27: A second wireless communication device for wireless communication, comprising one or more memories storing processor-executable code, and one or more processors coupled with the one or more memories and individually or collectively operable to execute the code to cause the second wireless communication device to perform a method of any of clauses 12 through 23.

Clause 28: A second wireless communication device for wireless communication, comprising at least one means for performing a method of any of clauses 12 through 23.

Clause 29: A non-transitory computer-readable medium storing code for wireless communication, the code comprising instructions executable by one or more processors to perform a method of any of clauses 12 through 23.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication at a first wireless communication device, comprising:
a processing system that includes processor circuitry and memory circuitry that stores code, the processing system configured to cause the apparatus to:
communicate, with a second wireless communication device via a first wireless communication link associated with a first wireless protocol, a first set of audio data associated with an application for the first wireless communication device;
receive, from the second wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol; and
communicate, with the second wireless communication device via the second wireless communication link during the triggering operation, a second set of audio data associated with the application in response to the request to switch.

2. The apparatus of claim 1, wherein the triggering operation comprises a roaming operation, and the processing system is further configured to cause the apparatus to:
monitor one or more channels associated with the first wireless communication link; and
transmit, via the first wireless communication link, a roaming indication in response to a channel quality of the one or more channels associated with the first wireless communication link falling below a threshold channel quality, wherein the request to switch audio communications is received in response to the roaming indication.

3. The apparatus of claim 2, wherein the processing system is further configured to cause the apparatus to:
receive, from a third wireless communication device and in accordance with the roaming indication, an indication of an internet protocol (IP) address for the first wireless communication device while communicating the second set of audio data with the second wireless communication device via the second wireless communication link.

4. The apparatus of claim 3, wherein the processing system is further configured to cause the apparatus to:
transmit the IP address to the second wireless communication device in response to the indication of the IP address while communicating the second set of audio data with the second wireless communication device via the second wireless communication link.

5. The apparatus of claim 1, wherein the triggering operation comprises a roaming operation, and the processing system is further configured to cause the apparatus to:
monitor one or more channels associated with the first wireless communication link; and
transmit, via the first wireless communication link, a roaming indication in response to a congestion level of the one or more channels associated with the first wireless communication link exceeding a threshold congestion level, wherein the request to switch audio communications is received in response to the roaming indication.

6. The apparatus of claim 1, wherein the triggering operation comprises a roaming operation, and the processing system is further configured to cause the apparatus to:
transmit a roaming request message comprising audio destination information, the audio destination information indicating the second wireless protocol for audio communications associated with the application.

7. The apparatus of claim 1, wherein the first wireless communication link comprises a peer to peer communication link and the second wireless communication link comprises a wireless local area network (WLAN) communication link, and the processing system is further configured to cause the apparatus to:
communicate, while communicating the second set of audio data with the second wireless communication device via the second wireless communication link, a third set of audio data associated with the application via the first wireless communication link.

8. The apparatus of claim 1, wherein the processing system is further configured to cause the apparatus to:
perform the triggering operation while communicating the second set of audio data with the second wireless communication device via the second wireless communication link, wherein the triggering operation comprises a channel scanning operation, a channel switching operation, a roaming operation, or any combination thereof.

9. The apparatus of claim 1, wherein, to communicate the second set of audio data, the processing system is configured to cause the apparatus to:
communicate the second set of audio data according to a second set of encoding parameters different from a first set of encoding parameters and corresponding to a reduced bit rate or increased latency relative to the first set of encoding parameters.

10. The apparatus of claim 1, wherein:
the first wireless protocol comprises one of wireless location area network (WLAN) protocol or BLUETOOTH protocol; and
the second wireless protocol comprises one of the BLUETOOTH protocol or the WLAN protocol.

11. An apparatus for wireless communication at a second wireless communication device, comprising:
a processing system that includes processor circuitry and memory circuitry that stores code, the processing system configured to cause the apparatus to:
communicate, with a first wireless communication device via a first wireless communication link associated with a first wireless protocol, a first set of audio data associated with an application for the first wireless communication device;
transmit, to the first wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol; and
communicate, with the first wireless communication device via the second wireless communication link during the triggering operation, a second set of audio data associated with the application in response to the request to switch.

12. The apparatus of claim 11, wherein the processing system is further configured to cause the apparatus to:
monitor one or more channels associated with the first wireless communication link, wherein the request to switch audio communications is transmitted in response to a channel quality of the one or more channels associated with the first wireless communication link falling below a threshold channel quality detected during the monitoring of the one or more channels.

13. The apparatus of claim 11, wherein the processing system is further configured to cause the apparatus to:
monitor one or more channels associated with the first wireless communication link, wherein the request to switch audio communications is transmitted in response to a congestion level of the one or more channels associated with the first wireless communication link falling below a threshold congestion level detected during the monitoring of the one or more channels.

14. The apparatus of claim 11, wherein the triggering operation comprises a roaming operation, and the processing system is further configured to cause the apparatus to:
receive a roaming indication, wherein the request to switch audio communications is transmitted in response to the roaming indication.

15. The apparatus of claim 14, wherein the roaming indication is received from the first wireless communication device, from one or more components of the second wireless communication device, or both.

16. The apparatus of claim 11, wherein the triggering operation comprises a roaming operation, and the processing system is further configured to cause the apparatus to:
receive, from the first wireless communication device, a roaming request message comprising audio destination information, the audio destination information indicating the second wireless protocol for audio communications associated with the application.

17. The apparatus of claim 16, wherein the processing system is further configured to cause the apparatus to:
receive, from the first wireless communication device, an internet protocol (IP) address of the first wireless communication device while communicating the second set of audio data with the first wireless communication device via the second wireless communication link.

18. The apparatus of claim 11, wherein the processing system is further configured to cause the apparatus to:
perform the triggering operation while communicating the second set of audio data with the first wireless communication device via the second wireless communication link, wherein the triggering operation comprises a channel scanning operation, a channel switching operation, a roaming operation, or any combination thereof.

19. The apparatus of claim 11, wherein the first wireless communication link comprises a peer to peer communication link and the second wireless communication link comprises a wireless local area network (WLAN) communication link, and the processing system is further configured to cause the apparatus to:
communicate, while communicating the second set of audio data with the first wireless communication device via the second wireless communication link, a third set of audio data associated with the application via the first wireless communication link.

20. A method for wireless communication at a first wireless communication device, comprising:
communicating, with a second wireless communication device via a first wireless communication link associated with a first wireless protocol, a first set of audio data associated with an application for the first wireless communication device;
receiving, from the second wireless communication device via the first wireless communication link, a request to switch audio communications associated with the application from the first wireless communication link to a second wireless communication link associated with a second wireless protocol in response to a triggering operation associated with one of the first wireless protocol or the second wireless protocol, the second wireless protocol different from the first wireless protocol; and
communicating, with the second wireless communication device via the second wireless communication link during the triggering operation, a second set of audio data associated with the application in response to the request to switch.
